(19) United States
(12) Patent Application Publication
(10) Pub. No.: US 2004/0254964 A1
(43) Pub. Date: Dec. 16, 2004

(54) Data replication with rollback

(76) Inventors: Shoji Kodama, San Jose, CA (US); Kenji Yamagami, Los Gatos, CA (US)

Correspondence Address: SQUIRE, SANDERS & DEMPSEY L.L.P, 600 HANSEN WAY, PALO ALTO, CA, 94304-1043, US

(21) Appl. No.: 10/459,743

(22) Filed: Jun. 12, 2003

(51) Int. Cl. G06F 17/30

(52) U.S. Cl. 707/204

(57) ABSTRACT

Aspects of the invention provide for a storage device to selectively replicate one or more data portions from a real dataspace to a virtual dataspace, and for selective rollback of data portions from the virtual dataspace to the real dataspace. Aspects further enable a storage device to preserve real data portions otherwise modified by a rollback to the virtual dataspace, for the use of same size real and virtual dataspaces, and for one or more variably sized extents or logs to be utilized.

### REFERENCES TO OTHER APPLICATIONS

This application hereby incorporates by reference co-pending application Ser. No. ______, entitled “Data Replication for Enterprise Applications”, filed on Jun. 12, 2003 by Shoji Kodama, et al.

### BACKGROUND OF THE INVENTION

1. Field of the Invention

This invention relates generally to computer systems, and more particularly provides a system and methods for providing data replication.

2. Background

Today's enterprise computing systems, while supporting multiple access requirements, continue to operate in much the same way as their small computing system counterparts. The enterprise computing system of FIG. 1, for example, includes application servers 101, which execute application programs that access data stored in storage 102. Storage 102 further includes a disk array configured as a redundant array of independent disks or “RAID”.

Disk array 102 includes an array controller 121a for conducting application server 112a-c data read/write access in conjunction with data volumes 122, 123a-c. Array controller 121 might also provide for support functions, such as data routing, caching, redundancy, parity checking, and the like, in conjunction with the conducting of such data access.

Array controller 121 provides for data access such that data stored by a data-originating server 111a-c can be independently used by applications running on more than one data-utilizing application server. Array controller 121 responds to a data-store request from a data-originating server 111 by storing “original” data to an original or “primary” volume. Array controller 121 then responds to an initial data request from a data-utilizing server 112 by copying the original volume to a “secondary” volume 123, and thereafter responds to successive data-store requests from server 112 by successively replacing the secondary volume with server 112 data modifications. The corresponding primary volume thus remains unmodified by server 112 operation, and can be used in a similar manner by other data-utilizing application servers.

Unfortunately, while proliferated, it is observed that such multiple access configurations can nevertheless become inefficient with regard to special uses of the stored data.

In a data backup application, for example, an application server 111 data-store request causes array controller 121 to store a database in primary volume 122. A backup server, e.g., server 112, requesting the database for backup to devices 113 (e.g., a tape backup), causes array controller 121 to copy the database to secondary volume 123. Since the potential nevertheless exists for database use during copying, secondary volume verification might be desirable. However, secondary volume replacement during verification might result in inconsistencies in the backed up secondary volume data, thus inhibiting verification.

In software testing, application servers 101 might depict a development system 11a, environment creator 111b and condition creator 111c that respectively store target software, a test environment and test conditions (together, “test data”) in primary volume 122. A tester 112 requesting the test data then causes array controller 102 to copy the test data to secondary volume 123, and successive data-store requests by tester 112 cause array controller 102 to successively replace the secondary volume with successive modifications by tester 112. Unfortunately, if the software, environment or conditions fail testing or require updating, then the corresponding potentially voluminous test data must be re-loaded from often remote sources.

In batch processing, application servers 101 might depict a database-creating server 111 storing database data in primary volume 122, and a batch processor 112. Batch processor 112 initially requesting the database causes array controller 102 to copy the data to secondary volume 123, and successive data-store requests by batch processor 112 sub-processes cause array controller 102 to successively replace the secondary volume with successively sub-processed data. Unfortunately, if a sub-process produces an error, then, following sub-process correction, the source data must again be loaded from its sources and the entire batch process must be repeated.

Accordingly, there is a need for systems and methods that enable multiple-accessing of data while avoiding the data re-loading or other disadvantages of conventional systems. There is also a need for systems and methods capable of facilitating applications for which special processing of generated data might be desirable.

### SUMMARY OF THE INVENTION

Aspects of the invention enable multiple accessing of data while avoiding conventional system disadvantages. Aspects also enable the storing, retrieving, transferring or otherwise accessing of one or more intermediate or other data results of one or more processing systems or processing system applications. Thus, aspects can, for example, be used in conjunction with facilitating data mining, data sharing, data distribution, data backup, software testing, batch processing, and so on, among numerous other applications.

In one aspect, embodiments enable a storage device to selectively replicate and/or retrieve one or more datasets that are intermittently or otherwise stored by an application server application onto the storage device. In another aspect, embodiments enables a storage device to respond to application server requests (or “commands”) by replicating data stored as a real data copy, e.g., primary or secondary volume, one or more times to a corresponding one or more virtual data copies, or to return or “rollback” a real data copy to previously stored virtual data. Another aspect enables selective rollback according to a one or more of a virtual copy time, date, name or other virtual data indicator. Aspects further enable a real and corresponding virtual data copy to utilize varying mechanisms, such as a physical media having a same size, to utilize one or more “extents”, for virtual data copy storage or to maintain one or more logs indicating overwritten virtual data and/or virtual volume creation, among further combinable aspects.

In a data replication method example according to the invention, upon receipt of a virtual copy request, a data storage device creates a virtual storage, and thereafter, upon receipt of a data store request including new data, the storage device replaces portions of the virtual storage with real data of a corresponding real storage and replaces portions of the real data with the new data.

A data replication system example comprises a storage device including a storage controller that provides for managing data storage and retrieval of real dataspace data, such as primary and secondary storage, and a virtual storage manager that provides for managing virtual dataspaces storing replicated real data. The virtual storage manager can, for example, enable one or more of pre-allocating a virtual dataspace that can further replicate the real dataspace, allocating a virtual dataspace as needed contemporaneously with storage or further utilizing extents, or using log volumes.

Advantageously, aspects of the invention enable a multiplicity of intermediate data results to be stored/restored without resorting to storing all data updates, as might otherwise unnecessarily utilize available storage space. Aspects further facilitate the management of such storage by a storage device without requiring modification to a basic operation of a data storage device. Aspects also enable one or more selected intermediate data results to be selectively stored or retrieved such that the results can be mined from or distributed among one or more processing systems or processing system applications. Other advantages will also become apparent by reference to the following text and figures.

### BRIEF DESCRIPTION OF THE DRAWINGS

FIG. 1 is a flow diagram a prior art data storage example;

FIG. 2 is a flow diagram illustrating an interconnected system employing an exemplary data replication system, according to an embodiment of the invention;

FIG. 3 is a flow diagram illustrating a processing system capable of implementing the data replication system of FIG. 2 or elements thereof, according to an embodiment of the invention;

FIG. 4 is a flow diagram illustrating an exemplary processing system based data replication system, according to an embodiment of the invention;

FIG. 5 is a flow diagram illustrating examples of data replication system operation, according to an embodiment of the invention;

FIG. 6 illustrates an exemplary command configuration, according to an embodiment of the invention;

FIG. 7a is a flow diagram illustrating examples of array control and virtual volume inter-operation, according to an embodiment of the invention;

FIG. 7b illustrates a virtual volume map according to an embodiment of the invention;

FIG. 7c illustrates a real volume map according to an embodiment of the invention FIG. 8 is a flow diagram illustrating a more integrated data replication system according to an embodiment of the invention;

FIG. 9 is a flowchart illustrating a method for responding to commands affecting virtual volumes according to an embodiment of the invention;

FIG. 10 is a flowchart illustrating an example of a volume pair creating method useable in conjunction with “same volume size” or “extent” embodiments, according to the invention;

FIG. 11 is a flowchart illustrating an example of a volume management structure useable in conjunction with a same volume size data replication embodiment, according to the invention;

FIG. 12 is a flowchart illustrating an example of a volume pair splitting method useable in conjunction with same volume size, extent or log embodiments, according to the invention;

FIG. 13 is a flowchart illustrating an example of a volume (re)synchronizing method useable in conjunction with same volume size, extent or log embodiments, according to the invention;

FIG. 14a is a flow diagram illustrating a method for forming a temporary bitmap, according to an embodiment of the invention;

FIG. 14b is a flow diagram illustrating a copied volume (re)synchronizing method useable in conjunction with a temporary bitmap, according to an embodiment of the invention;

FIG. 15 is a flowchart illustrating an example of a volume pair deleting method useable in conjunction with same volume size, extent or log embodiments, according to the invention;

FIG. 16 is a flowchart illustrating an example of a volume reading method useable in conjunction with same volume size, extent or log embodiments, according to the invention;

FIG. 17a is a flowchart illustrating an example of a volume writing method useable in conjunction with same volume size, extent or log embodiments according to the invention;

FIG. 17b is a flowchart illustrating an example of a write procedure useable in conjunction with a same volume size embodiment, according to the invention;

FIG. 18a is a flowchart illustrating an example of a checkpoint method useable in conjunction with a same volume size embodiment, according to the invention;

FIG. 18b is a flow diagram illustrating a checkpoint and data writing method useable in conjunction with a same volume size embodiment, according to the invention;

FIG. 18c is a flow diagram illustrating an example of a checkpoint and data writing method useable in conjunction with a same volume size embodiment, according to the invention;

FIG. 19a is a flowchart illustrating an example of a rollback method useable in conjunction with a same volume size embodiment, according to the invention;

FIG. 19b is a flow diagram illustrating an example of a rollback method useable in conjunction with a same volume size embodiment, according to the invention;

FIG. 20a is a flowchart illustrating an example of a checkpoint deleting method useable in conjunction with a same volume size embodiment, according to the invention;

FIG. 20b illustrates an example of a checkpoint deleting method useable in conjunction with a same volume size embodiment, according to the invention;

FIG. 21 illustrates an exemplary data management structure useable in conjunction with an extents embodiment, according to the invention;

FIG. 22 is a flowchart illustrating an example of a write procedure useable in conjunction with an extents embodiment, according to the invention;

FIG. 23a is a flowchart illustrating an example of a checkpoint method useable in conjunction with an extents embodiment, according to the invention;

FIG. 23b is a flow diagram illustrating an example of a checkpoint and data writing method useable in conjunction with an extents embodiment, according to the invention;

FIG. 23c is a flow diagram illustrating an example of a checkpoint and data writing method useable in conjunction with an extents embodiment, according to the invention;

FIG. 24a is a flowchart illustrating an example of a rollback method useable in conjunction with an extents embodiment, according to the invention;

FIG. 24b is a flow diagram illustrating an example of a rollback method useable in conjunction with an extents embodiment, according to the invention;

FIG. 25a is a flowchart illustrating an example of a checkpoint deleting method useable in conjunction with an extents embodiment, according to the invention;

FIG. 25b is a flow diagram illustrating an example of a checkpoint deleting method useable in conjunction with an extents embodiment, according to the invention;

FIG. 26 is a flow diagram illustrating an example of a log-type virtual volume and an example of a checkpoint and data write method useable in conjunction with a log embodiment, according to an embodiment of the invention;

FIG. 27 is a flow diagram illustrating an exemplary volume management structure useable in conjunction with a log embodiment, according to the invention;

FIG. 28 is a flowchart illustrating an example of a pair creating method useable in conjunction with a log embodiment, according to the invention;

FIG. 29 is a flowchart illustrating an exemplary write procedure useable in conjunction with a log embodiment, according to the invention;

FIG. 30a is a flowchart illustrating an example of a checkpoint method useable in conjunction with a log embodiment, according to the invention;

FIG. 30b is a flow diagram illustrating an example of a checkpoint and data write method useable in conjunction with a log embodiment, according to the invention;

FIG. 31a is a flowchart illustrating an exemplary rollback method useable in conjunction with a log embodiment, according to the invention;

FIG. 31b illustrates an exemplary rollback method useable in conjunction with a log embodiment, according to the invention;

FIG. 32a is a flowchart illustrating an example of a checkpoint deleting method useable in conjunction with a log embodiment, according to the invention;

FIG. 32b is a flow diagram illustrating an example of a checkpoint deleting method useable in conjunction with a log embodiment, according to the invention;

FIG. 33a illustrates a virtual volume manager according to an embodiment of the invention; and

FIG. 33b illustrates an array controller according to an embodiment of the invention.

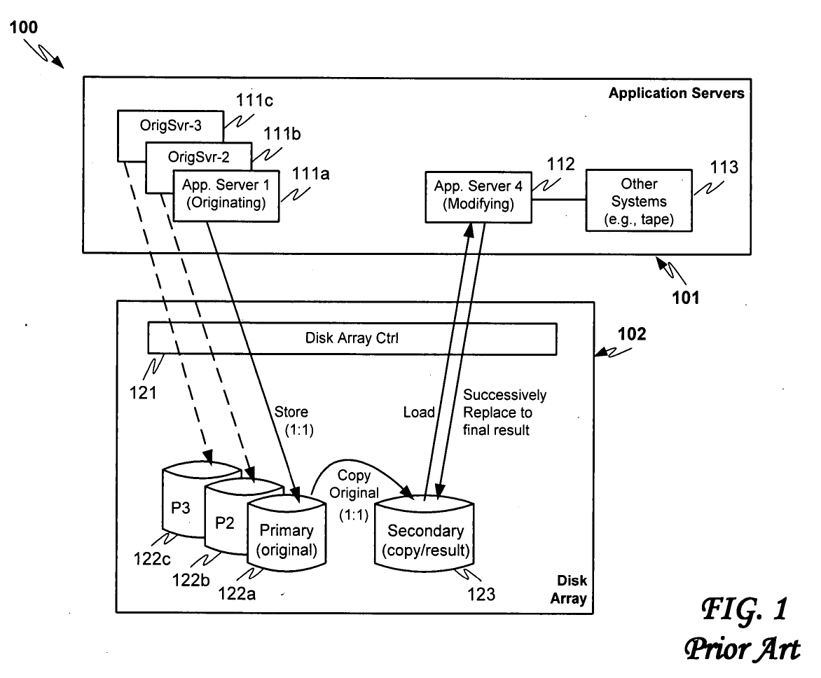

### DETAILED DESCRIPTION

In providing for data replication systems and methods, aspects of the invention enable one or more of datasets that are successively stored in a storage device dataspace, such as a secondary volume, to be preserved in whole or part in one or more further stored “virtual” copies. Aspects also enable a “rollback” of a potentially modified dataspace to a selectable one or more portions of one or more virtual copies of previous data of the dataspace. Aspects further enable flexible management of virtual copies using various data storage mechanisms, such as similarly sized real and virtual volumes, extents, or logs, among others. Aspects also enable limited or selectable storage/retrieval of virtual copies, security or conducting of enterprise or other applications by a storage device, among still further combinable aspects.

Note that the term “or”, as used herein, is intended to generally mean “and/or”, unless otherwise indicated. Reference will also be made to application servers as “originating” or “modifying”, or to system/processing aspects as being applicable to a particular device or device type, so that the invention might be better understood. Data storage references are also generally referred to as “volumes”. It will be appreciated, however, that servers or other devices might perform different or multiple operations, or might originate and process data. It will also become apparent that aspects might be applicable to a wide variety of devices or device types, and that a wide variety of dataspace references other than volumes might also be used, among other combinable permutations in accordance with the requirements of a particular implementation. Such terms are not intended to be limiting.

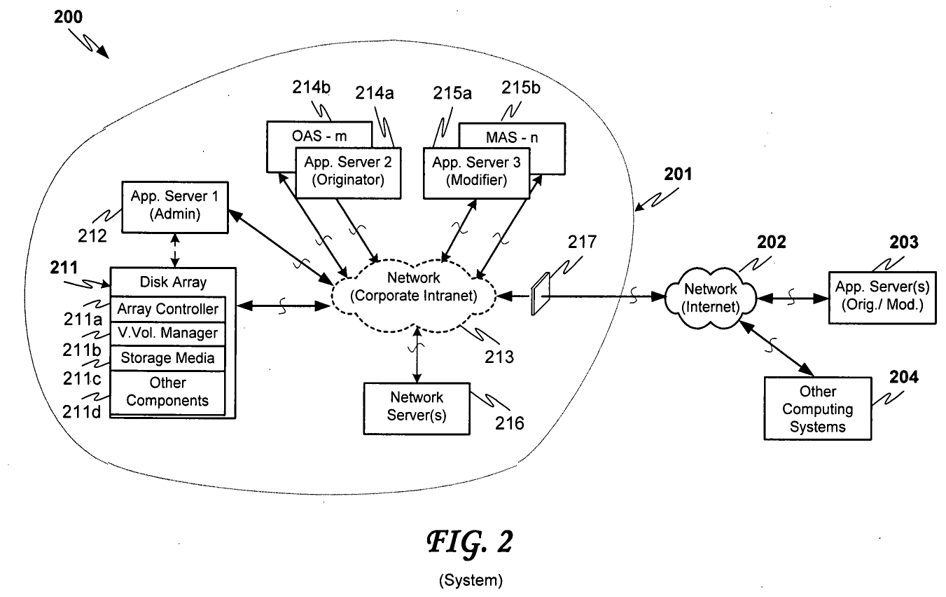

Turning to FIG. 2, aspects of the invention enable data replication and rollback to be used in conjunction with a wide variety of system configurations in accordance with the requirements of a particular application. Here, an exemplary system 200 includes one or more computing devices and data-replication enabled storage devices coupled via an interconnected network 201, 202. Replication system 200 includes interconnected devices 201 coupled via intranet 213, including data replication enabled disk array 211, application servers 212, 214a-b, 215a-b and network server 216. System 200 also includes similarly coupled application servers 203 and other computing systems 204. System 200 can further include one or more firewalls (e.g., firewall 217), routers, caches, redundancy/load balancing systems, backup systems or other interconnected network elements (not shown), according to the requirements a particular implementation.

Data replication can be conducted by a storage device, or more typically, a disk array or other shared (“multiple access”) storage, such as the redundant array of independent disks or “RAID” configured disk array 211. Note, however, that a replication-enabled device can more generally comprise one or more unitary or multiple function storage or other device(s) that are capable of providing for data replication with rollback in a manner not inconsistent with the teachings herein.

Disk array 211 includes disk array controller 211a, virtual volume manager 211b and an array of storage media 211c. Disk array 211 can also include other components, such as for enabling caching, redundancy, parity checking, or other storage or support features (not shown) according to a particular implementation. Such components can, for example, include those found in conventional disk arrays or other storage system devices, and can be configured in an otherwise conventional manner, or otherwise according to the requirements of a particular application.

Array controller 211a provides for generally managing disk array operation in conjunction with “real datasets”, which management can be conducted in an otherwise conventional manner, such as in the examples that follow, or in accordance with a particular implementation. Such managing can, for example, include communicating with other system 200 devices and conducting storage, retrieval and deletion of application data stored in real dataspaces, such as files, folders, directories and so on, or multiple access storage references, such as primary or secondary volumes. For clarity sake, however, dataspaces are generally referred to herein as “volumes”, unless otherwise indicated; ordinary or conventional data storage dataspaces are further generally referred to as “real” volumes, as contrasted with below discussed “virtual” volumes.

Array controller 211a more specifically provides for managing real volumes of disk array 211, typically in conjunction with requests from data-originating server applications that supply source data, and from data-modifying application servers that utilize the source data. Array controller 211a responds to requests from data-originating application server applications by conducting corresponding creating, reading, writing or deleting of a respective “original volume”. Array controller 211 further responds to “Pair_Create” or “Pair_Split” requests, as might be received from a user or data-originating application server or data-modifying application server.

Broadly stated, upon and following a “Pair_Create” request or upon disk array 211 (automatic) initiation, array controller 211a creates a secondary volume corresponding to the primary volume, if such secondary volume does not yet exist; array controller 211a further inhibits Data_Write and Data_Read requests to and from the secondary volume, and copies data stored in the original volume to the secondary volume, thereby synchronizing the secondary volume with the original volume. Array controller 211a responds to a “Pair_Split” request by enabling Data_Write and Data_Read operations respecting the secondary volume, but suspends the synchronizing of the original volume to the secondary volume.

Array controller 211a also responds to requests from data-modifying application server applications by conducting corresponding creating, reading, writing or deleting of respective secondary volumes. A pair request is typically initiated prior to a modifying server issuing a Data_Read or Data_Write request, such that a secondary volume corresponding a primary volume is created and the secondary volume stores a copy of the primary volume data; a Pair_Split request is then initiated, thus enabling secondary volume Data_Read and Data_Store operations. Assuming that a further pair request does not occur, array controller 211a responds to successive Data_Store requests from a data-modifying application server application, including successively replacing the indicated secondary storage data with data modifications provided by the requesting server, thus leaving the original volume intact. Array controller 211a responds to a Data_Read request, including returning the indicated volume data to the requesting server, and to a secondary volume Delete command by deleting the indicated secondary volume.

Accordingly, secondary volumes are also referred to herein as “copied” volumes (e.g., reflecting pair copying), secondary volume data can also be referred to alternatively as “resultant data”. (e.g., reflecting storage of modified data) and original and secondary volumes together comprise the aforementioned “real volumes” with regard to device 211.

(A non-initial Pair_Create or “ReSync” request would also inhibit corresponding secondary volume access and initiate copying of the original volume to the secondary volume, for example, to enable synchronizing of secondary volume with modifications to corresponding primary volume source data. Typically, however, only primary volume data portions that have been modified since a last copy operation are copied to a corresponding secondary volume, as is discussed further below. Thus, where partial data copying is enabled, an initial Pair_Create request can directly cause the copying of all primary storage data to the corresponding secondary storage; alternatively, an initial request can copy, to the secondary volume, data portions that are indicated as not yet having been copied wherein all of the corresponding primary volume data is so indicated, thus enabling a single command in initial as well as non-initial cases.)

Array controller 211a also provides for management of other disk array components that can include but are not limited to caching, redundancy, parity checking, or other storage or support features. Array controller 211a might further be configured in a more or less integrated manner or to otherwise inter-operate with virtual volume manager 211b operation to various extents, in accordance with a particular implementation.

In a more integrated configuration, array controller 211a might, for example, provide for passing application server access requests to virtual volume manager 211b, or responses from virtual volume manager 211b to application server applications. Array controller 211a might further provide for virtual volume command interpretation, or respond to virtual volume manager 211b requests by conducting storage, retrieval or other operations. Array controller 211a can further be integrated with a disk controller or other components.

(It will be appreciated that a tradeoff exists in which greater integration of virtual volume management might avoid duplication of some general purpose storage device control functionality that is adaptable in accordance with aspects of the present invention. Conversely, lesser integration might enable greater compatibility with existing storage or host device implementations.)

Virtual volume or “V.Vol” manager 211b provides for creating, writing, reading, deleting or otherwise managing one or more virtual volumes, or for enabling the selective storing, retrieving or other management of virtual volume data, typically within storage media 211c.

Virtual volumes, as with other volume types, provide designations of data storage areas or “dataspaces”, e.g., within storage media 211c, that are useable for storing application data, and can be referenced by other system 200 elements (e.g., via network 201, 202). “Snapshots” of resultant application sever data successively stored in a secondary volume can, for example, be replicated at different times to different virtual volumes and then selectively restored as desired.

Virtual volumes of disk array 211 can selectively store, from a secondary volume, a multiplicity of intermediately produced as well as original or resultant data, or merely secondary volume data portions that are to be modified in the secondary volume but have not yet been stored in a virtual volume. Such data portions can, for example, include one or more segments (A segment includes a continuous or discontinuous data portion, the size and number of which can define a volume, and which are definable, according to the requirements of a particular application.) Accordingly, virtual volume data is also referred to herein as “intermediate data”, regardless of whether the data selected for storage therein corresponds with original, intermediately stored, resultant or further processed data, or whether such data is replicated in whole or part, unless indicated otherwise.

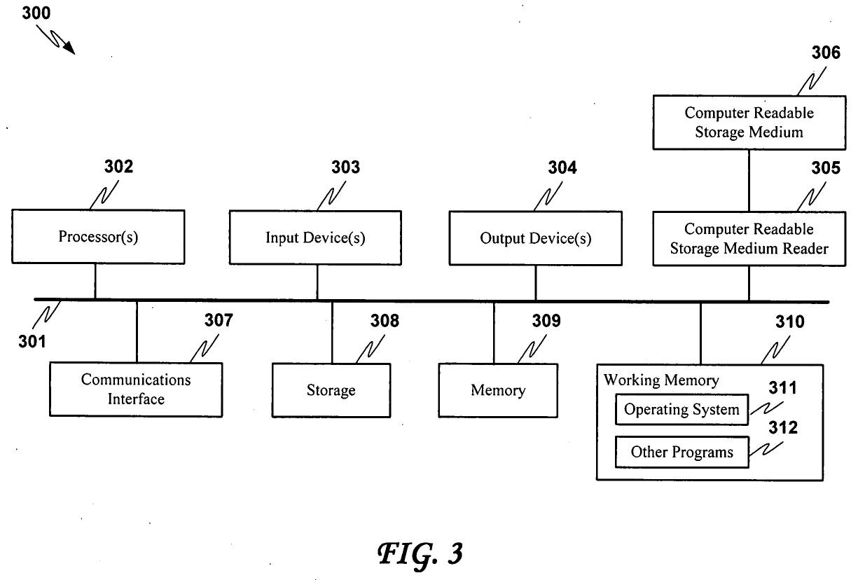

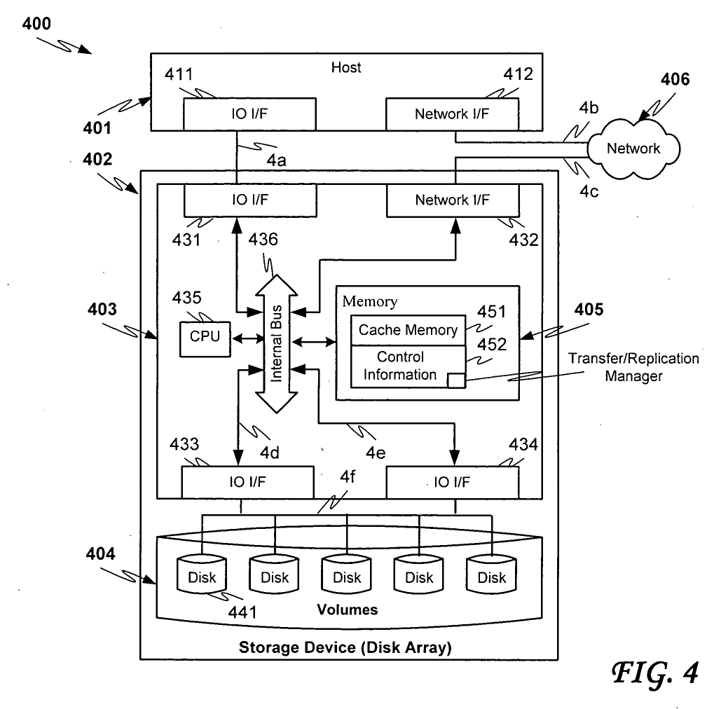

Virtual volumes can be managed automatically, e.g., programmatically, or selectively in conjunction with application, user selection or security operations/parameters that might be used, or otherwise in accordance with a particular application. For example, virtual volume manager 211b can be configured to monitor real volume accessing or array controller operation, e.g., using otherwise conventional device monitoring or event/data transfer techniques, and to automatically respond with corresponding virtual volume creation, storage, retrieval or other operations, e.g., in conducting data backup, data mining or other applications. Virtual volume manager 211b can also be configured to initiate included operations in conjunction with one or more applications, for example, storing and executing program instructions in a similar manner as with conventional application servers or similarly operating in response to startup or other initiation by one or more of a user, server, event, timing, and so on (E.g., see FIGS. 3-4).

Virtual volume manager 211b might, for example, initiate or respond to monitored data accessing by storing snapshots of application data from different servers in virtual volumes or by storing data portions, such that the application data at the time of virtual storage can be reconstructed. Virtual volume manager 211b might also distribute virtual volume data to one or more application servers. Server-initiated plus such automatic operation can also be similarly configured, among other combinable alternatives.

More typically, however, virtual volume manager 211b provides for managing virtual volumes in response to application server application requests or “commands”. Such commands can be configured uniquely or can be configured generally in accordance with array controller 211a commands, thereby facilitating broader compatibility with array controller operation of an existing device.

Virtual volume manager 211b typically responds to a command in a more limited way, including correspondingly creating a virtual volume (e.g., see “checkpoint” request below), replicating secondary volume data to a virtual volume, replicating virtual volume data to a secondary volume, e.g., in conjunction with a rollback of the secondary volume to a previous value, or deleting a virtual volume. Greater processing/storage capability of a replication enabled device would, however, also enable the teachings herein to be utilized in conjunction with a broader range of combinable or configurable commands or features, only some of which might be specifically referred to herein.

Virtual volume manager 211b can be configured to communicate more directly with application server applications, or conduct management aspects more indirectly, e.g., via array controller 211a, in accordance with the requirements of a particular implementation. For example, virtual volume manager 211b might, in a more integrated implementation, receive application server commands indirectly via array controller 211a or respond via array controller 211a, or array controller 211a might conduct such interaction directly. Virtual volume manager 211b might also receive commands by monitoring array controller store, load, delete or other operations, or provide commands to array controller 211a (e.g., as with an application) for conducting virtual volume creation, data-storing, data-retrieving or other management operations.

Virtual volume manager 211a might further utilize a cache or other disk array 211 components, though typically in an otherwise conventional manner in conjunction with data management, e.g., in a similar manner as with conventional array controller management of volumes referred to herein as “real volumes”. It will be appreciated that array controller 211a or virtual volume manager 211b might also be statically or dynamically configurable for providing one or more implementation alternatives, or otherwise vary in accordance with a particular application, e.g., as discussed with reference to FIGS. 3-4.

Of the remaining disk array 211 components, storage media 211c provides a physical media into which data is stored, and can include one or more of hard disks, optical or other removable/non-removable media, cache memory or any other suitable storage media in accordance with a particular application. Other components can, for example, include error checking, caching or other storage or application related components in accordance with a particular application. (Such components are, for example, commonly utilized with regard to real volumes in conjunction with mass or multiple access storage, such as disk arrays, or with other networked or stand alone processing systems.) Application servers 214a-b, 215a-b, 203, 204 provide for user/system processing within system 200 and can include any devices capable of storing data to storage 211, or further directing or otherwise inter-operating with virtual volume manager 211b in accordance with a particular application. Such devices might include one or more of workstations, personal computers (“PCs”), handheld computers, settop boxes, personal data assistants (“PDAs”), personal information managers (“PIMs”), cell phones, controllers, so-called “smart” devices or even suitably configured electromechanical devices, among other devices.

Of the remaining system 200 components, networks 213 and 202 can include static or reconfigurable local or wide area networks (“LANs”, “WANs”), virtual networks (e.g., VPNs), or other interconnections in accordance with a particular application. Network server(s) 216 can further comprise one or more application servers configured in a conventional manner for network server operation (e.g., for conducting network access, email, system administration, and so on).

Turning now to FIG. 3, an exemplary processing system is illustrated that can comprise one or more of the elements of system 200 (FIG. 2). While other alternatives might be utilized, it will be presumed for clarity sake that elements of system 200 are implemented in hardware, software or some combination by one or more processing systems consistent therewith, unless otherwise indicated.

Processing system 300 comprises elements coupled via communication channels (e.g., bus 301) including one or more general or special purpose processors 202, such as a Pentium®, Power PC®, digital signal processor (“DSP”), and so on. System 300 elements also include one or more input devices 303 (such as a mouse, keyboard, microphone, pen, etc.), and one or more output devices 304, such as a suitable display, speakers, actuators, etc., in accordance with a particular application.

System 300 also includes a computer readable storage media reader 305 coupled to a computer readable storage medium 306, such as a storage/memory device or hard or removable storage/memory media; such devices or media are further indicated separately as storage device 308 and memory 309, which can include hard disk variants, floppy/compact disk variants, digital versatile disk (“DVD”) variants, smart cards, read only memory, random access memory, cache memory, and so on, in accordance with a particular application. One or more suitable communication devices 307 can also be included, such as a modem, DSL, infrared or other suitable transceiver, etc. for providing inter-device communication directly or via one or more suitable private or public networks that can include but are not limited to those already discussed.

Working memory 310 (e.g., of memory 309) further includes operating system (“OS”) 311 elements and other programs 312, such as application programs, mobile code, data, etc., for implementing system 200 elements that might be stored or loaded therein during use. The particular OS can vary in accordance with a particular device, features or other aspects in accordance with a particular application (e.g. Windows, Mac, Linux, Unix or Palm OS variants, a proprietary OS, etc.). Various programming languages or other tools can also be utilized. It will also be appreciated that working memory 310 contents, broadly given as OS 311 and other programs 312, can vary considerably in accordance with a particular application.

When implemented in software (e.g. as an application program, object, agent, downloadable, servlet, and so on in whole or part), a system 200 element can be communicated transitionally or more persistently from local or remote storage to memory (or cache memory, etc.) for execution, or another suitable mechanism can be utilized, and elements can be implemented in compiled or interpretive form. Input, intermediate or resulting data or functional elements can further reside more transitionally or more persistently in a storage media, cache or other volatile or non-volatile memory (e.g., storage device 307 or memory 308), in accordance with a particular application.

The FIG. 4 example further illustrates how data replication can be conducted using a disk array in conjunction with a dedicated host. FIG. 4 also shows an example of a more integrated, processor-based array controller and virtual volume manager combination, i.e., array manager 403. As shown, replication system 400 includes host 401, storage device 402 and network 406. Host 401, which can correspond to system 300 of FIG. 3, has been simplified for greater clarity, while a processor-based storage device implementation (i.e., disk array 402) that can also correspond to system 300 of FIG. 3 is shown in greater detail.

Host 401 is coupled and issues requests to storage device 402 via corresponding I/O interfaces 411 and 431 respectively, and connection 4a. Connection 4a can, for example, include a small computer system interface (“SCSI”), fiber channel, enterprise system connection (“ESCON”), fiber connectivity (“FICON”) or Ethernet, and interface 411 can be configured to implement one or more protocols, such as one or more of SCSI, iSCSI, ESCON, fiber FICON, among others. Host 401 and storage device 402 are also coupled via respective network interfaces 412 and 432, and connections 4b and 4c, to network 406.

Such network coupling can, for example, include implementations of one or more of Fibre Channel, Ethernet, Internet protocol (“IP”), or asynchronous transfer mode (“ATM”) protocols, among others. The network coupling also enables host 401 and storage device 402 to communicate via network 406 with other devices coupled to network 406, such as application servers 212, 214a-b, 215a-b, 216, 203 and 204 of FIG. 2. (Interfaces 411, 412, 431, 432, 433 and 434 can, for example, correspond to communications interface 307 of FIG. 3.) Storage device 402 includes, in addition to interfaces 431-434, storage device controller 403 and storage media 404.

Within array manager 403, CPU 435 operates in conjunction with control information 452 stored in memory 405 and cache memory 451, and via internal bus 436 and the other depicted interconnections for implementing storage control and data replication operations. (The aforementioned automatic operation or storage device initiation of real/virtual volume management can also be conducted in accordance with data stored or received by memory 405.) Cache memory 451 provides for temporarily storing write data sent from host 401 and read data read by host 401. Cache memory 451 also provides for storing pre-fetched data, such as a sequence of read/write requests from host 401.

Storage media 404 is coupled to and communicates with storage device controller 403 via I/O interfaces 433, 404 and connection 4f. Storage media 404 includes an array of disk drives 441 that can be configured as one or more of RAID, just a bunch of disks (“JBOD”) or any other suitable configuration in accordance with a particular application. Storage media 404 is more specifically coupled via internal bus 436 and connections 4d-f to CPU 435, which CPU conducts management of portions of the disks as volumes (e.g., primary, secondary and virtual volumes), and enables host access to storage media via referenced volumes only (i.e., and not the physical media). CPU 435 can further conduct the aforementioned security, applications or other aspects or other features in accordance with a particular implementation.

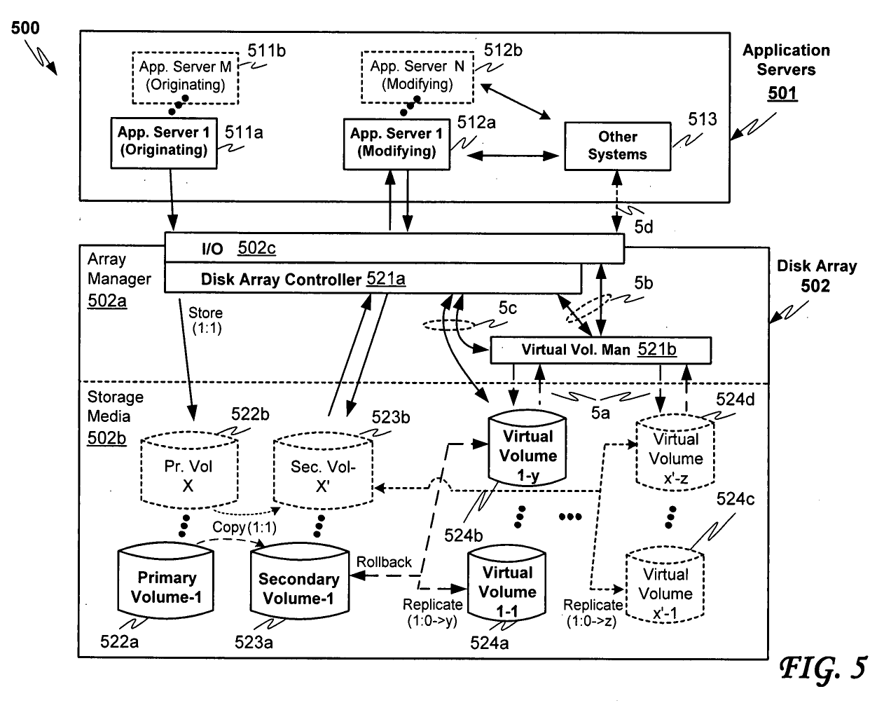

The FIG. 5 flow diagram illustrates an example of a lesser integrated data replication system according to the invention. System 500 includes application servers 501, and disk array 502. Application servers 501 further include originating application servers 511a-b, modifying application servers 512a-b and other devices 513, and disk array 502 further includes array manager 502a, storage media 502b, and network or input output interface, (“I/O”) 502c. Array manager 502a includes array controller 521a and virtual volume manager 521b, while storage media 502b includes one or more each of primary volumes 522a-522b, secondary volumes 523a-522b and virtual volumes 524a-b and 524c-d.

For greater clarity, signal paths within system 500 are indicated with a solid arrow, while potential data movement between components is depicted by dashed or dotted arrows. Additionally, application servers 501, for purposes of the present example, exclusively provide for either supplying original data for use by other servers (e.g., originating application servers 1-M 511a, 511b) or utilizing data supplied by other application servers (e.g., modifying application servers 1-n 512a, 512b). Each of application servers 511a-b, 512a-b communicates data access requests or “commands” via I/O 502c to array manager 502a.

Originating application server 511a-b applications issue data storage (“Data_Write”) requests to array controller 521a, causing array controller 521a to store original data into a (designated) primary volume, e.g., 522a. Originating application server 511a-b applications can further issue Data_Read requests, causing array controller 521a to return to the requesting server the requested data in the original volume. Originating or modifying application server applications can also issue Pair or Pair_Split requests, in the manner already discussed. (It will be appreciated that reading/writing of volume portions might also be similarly implemented.)

Originating application servers 511a-b generally need not communicate with virtual volume manager 521b. Further, the one or more primary volumes 522a-b that might be used generally need not be coupled to virtual volume manager 521b, since servers 511a-b do not modify data and primary volume data is also available, via copying, from the one or more of secondary volumes 523a-b that might be used. Thus, unless a particular need arises in a given implementation, system 500 can be simplified by configuring disk array 502 (or other storage devices that might also be used) without such capability.

Modifying application server 512a-b applications can, in the present example, issue conventional Data_Store and Data_Write commands respectively for reading from or writing to a secondary volume, except following a pair request (e.g., see above). Modifying application servers can also issue a simplified set of commands affecting virtual volumes including Checkpoint, Rollback, Data_Store and Virtual Volume Delete requests, such that the complexity added by way of virtual volume handling can be minimized.

A Checkpoint request causes virtual volume manager 521b to create a virtual volume (e.g., virtual volume 1-1, 524a) corresponding to an indicated secondary storage. Thereafter, virtual volume manager 521b responds to further Data_Write requests by causing data stored in an indicated secondary volume segment to be stored to a last created virtual volume. One or more virtual volume identifiers, typically including a creation or storage timestamp, are further associated with each virtual volume.

A rollback request causes virtual volume manager 521b to restore a secondary volume by replicating at least a portion of at least one virtual volume to the secondary volume. Finally, virtual volume manager 521b responds to a virtual volume delete request by deleting the indicated virtual volume. (As will be discussed, determination of applicable segments or copying of included segments from more than one virtual volume may also be required for reconstructing a real volume prior dataset where only segments to be overwritten in a subject real volume have been replicated to a virtual volume; similarly, deleting where a virtual volume stores only secondary volume “segments to be written” may require copying of virtual volume segments that are indicated for deletion, such that remaining virtual volumes remain usable to provide for rollback of a real volume.)

It will be appreciated that various alternatives might also be employed. For example, a snapshot of the secondary storage might be replicated to a virtual volume in response to a Checkpoint command. It is found, however, that the separating of virtual volume creation and populating enables a desirable flexibility. A virtual volume can, for example, be created by a separate mechanism (e.g., program function) from that populating the virtual volume, or further, a separate application, or still further, a separate application server. Additional flexibility is also gained by a Checkpoint command initiating ongoing replication of secondary volume data rather than simply a single snapshot of secondary storage data, since a single snapshot can be created by simply issuing a further Checkpoint command following a first Data-Write, without requiring additional commands. Successive data storage to more than one segment of a virtual volume is also facilitated by enabling successive Data_Write requests to be replicated to a same virtual volume, among other examples.

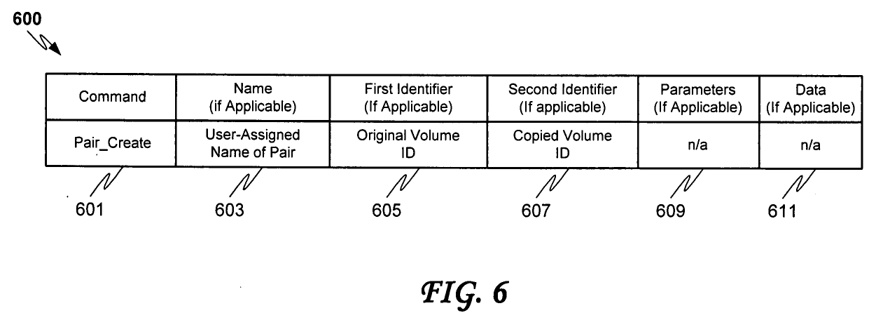

FIG. 6 illustrates an example of a command format that can be used to issue the aforementioned commands. The depicted example includes a command 601, a name 603 (typically, a user supplied reference that is assigned upon first receipt), a first identifier 605 for specifying an addressable data portion ID, such as a group, first or source volume, a second identifier 607 for specifying a further addressable ID, such as a second or destination volume, any applicable parameters 609, such a size corresponding to any (included) data that is included with the command or accessed by the command, and any included data 611. Thus, a Pair_Create command consistent with the depicted format can include the Pair_Create command 601, a user-assigned name to be assigned to the pair (and stored in conjunction with such command for further reference), and an original volume ID 605 and a copied volume ID 607 pair identifying the specific volumes to be paired. A command set example corresponding to the command format of FIG. 6 the command examples discussed herein is also shown in the following Chart 1.

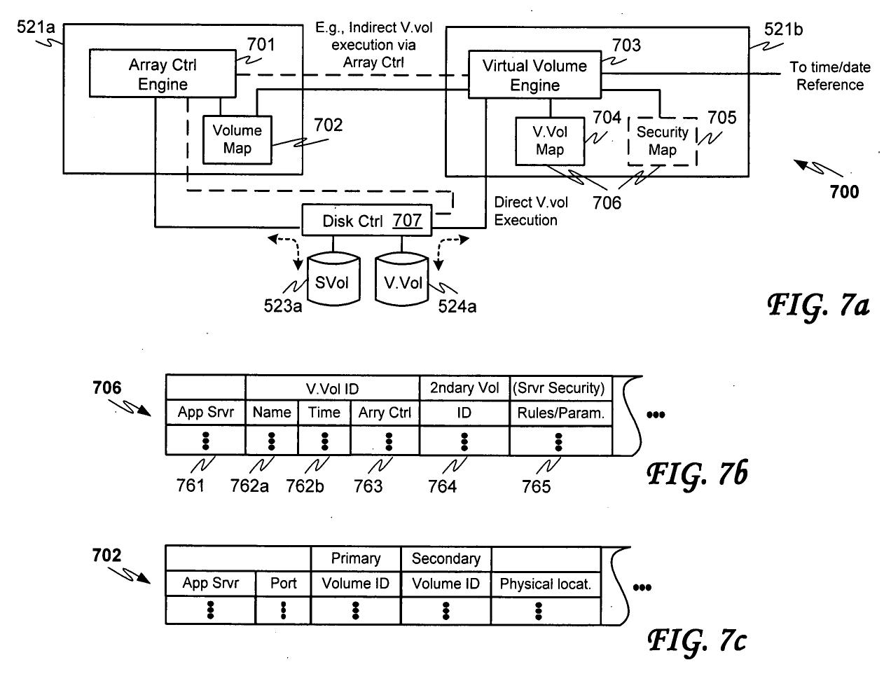

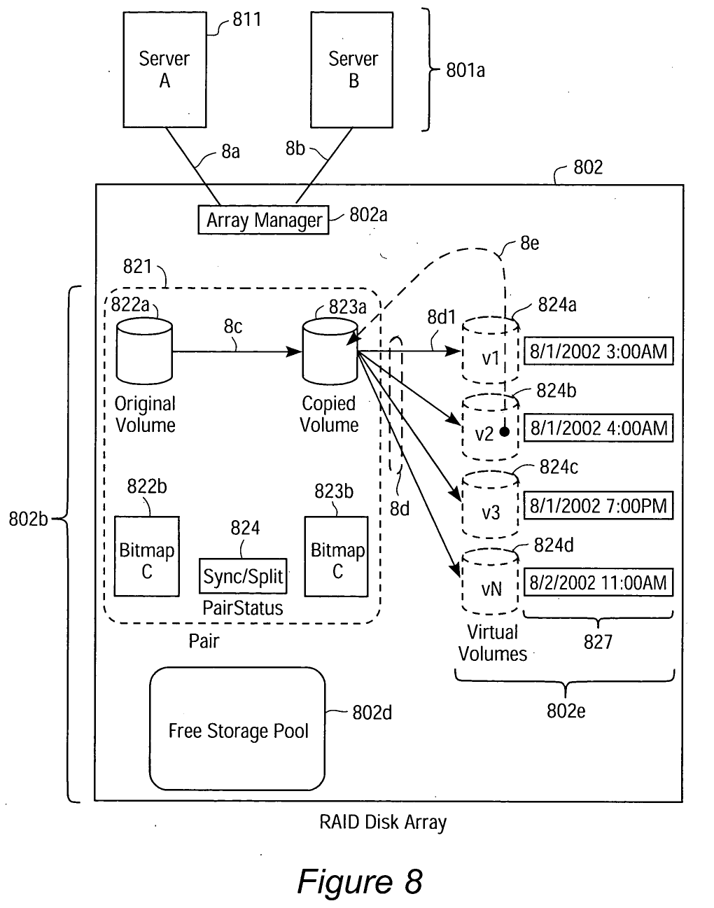

FIGS. 7a-7c further illustrate an example of how management of real and virtual disk array operation can be implemented in conjunction with discrete or otherwise less integrated array controller 521a and virtual volume manager 521b functionalities. As shown, array controller 521a includes array engine 701, which conducts array control operation in conjunction with the mapping of primary and secondary volumes to application servers and physical media provided by volume map 702. Virtual volume manager 521b includes virtual volume engine 703, which conducts virtual volume management operation in conjunction with volume map 702, and optionally, further in accordance with security map 705. Virtual volume manager 521b also includes an interconnection 7a to a time and date reference source, which can include any suitable local or remote time or date reference source(s).

TABLE 1
Exemplary Command Set and Command Formats

| | | | | Param- | |
|---|---|---|---|---|---|
| Command | Name | First ID | Second ID | eters | Data |
| Pair_Create | (User) | Orig. Vol. | Copied | n/a | n/a |
| | Assigned | | Vol. | | |
| | Pair Name | | | | |
| Pair_Resync | Assigned | n/a | n/a | n/a | n/a |
| | Pair Name | | | | |
| Pair_Delete | Assigned | n/a | n/a | n/a | n/a |
| | Pair Name | | | | |
| Data_Read | n/a | Orig/copied | Offset from | Data Size | n/a |
| | | Vol. ID | Vol. start | (to be | |
| | | | | read) | |
| Data_Write | n/a | Orig/copied | Offset from | Data Size | Data |
| | | Vol. ID | Vol. start | | |
| CheckPoint | Assigned | n/a | n/a | n/a | n/a |
| | Pair Name | | | | |
| Rollback | Assigned | V.Vol ID | n/a | n/a | n/a |
| | Pair Name | or | | | |
| | | timestamp | | | |
| Delete | Assigned | V.Vol ID | n/a | n/a | n/a |
| CheckPoint | Pair Name | or | | | |
| | | timestamp | | | |

Each of array controller 521a and virtual volume manager 521b can, for example, determine corresponding real and virtual volume references according to data supplied by a request, stored or downloaded data (e.g., see FIGS. 3-4) or further, by building and maintaining respective real and virtual volume maps. Virtual volume manager 521b can, for example, poll real volume map 702 prior to executing a command (or the basic map can be polled at startup and modifications to the map can be pushed to virtual volume controller, and so on), and can determine therefrom secondary volume correspondences, as well as secondary volume assignments made by array controller 521a for referencing virtual volumes. (See, for example, the above-noted co-pending patent application.)

Virtual volume manager 521b can further add such correspondences to map 704 and add its own virtual volume assignments to map 704. Virtual volume manager 521b can thus determine secondary volume and virtual volume references as needed by polling such a composite mapping (or alternatively, by reference to both mappings). Other determining/referencing mechanisms can also be used in accordance with a particular implementation.

Virtual volume manager 521b can further implement security protocols by comparing an access attempt by an application server, application, user, and so on, to predetermined rules/parameters stored in map 704 indicating those access attempts that are or are not allowable. Such access attempts might, for example, include one or more of issuing a rollback or deleting virtual volumes generally or further in accordance with specific further characteristics, among other features. Array controller 521a can also operate in a similar manner with respect to map 702. (Examples of maps 704 and 702 are depicted in FIGS. 7b and 7c, respectively.)

More integrated examples of replication with rollback will now be discussed in which an array controller and a virtual volume manager are combined in an array manager, e.g., as in FIG. 4. A disk controller can further be integrated into the array manager or separately implemented for conducting direct low level control of the disk array, for example, as discussed above. A RAID configuration is also again depicted for consistency, such that the invention might be better understood. (It should be understood that management relating to real volumes can also be substantially conducted by array controller functionality, management relating to virtual volumes can be substantially conducted by a virtual volume manager functionality and other management can be allocated as needed, subject to the requirements of a particular implementation. Automatic operation can further be implemented in the following embodiments, for example, in substantially similar manners as already discussed, despite the greater integration.)

Beginning with FIG. 8, servers 801a are coupled via network 801b to disk array 802, which disk array includes array manager 802a and data storage structures 802b. Data storage structures 802b further include real data storage 802d, free storage pool 802d and virtual data storage 802e. Real data storage 802c further includes at least one each of an original volume 822a, an original volume (bit) map 822b, a copied volume 823a, a copy volume (bit) map 823b and a sync/split status indicator 824. Virtual data storage further includes at least one each of a free storage pool 802d and virtual volumes 802e. (Note that more than one array manager might also be used, e.g., with each array manager managing one or more original and copied volume pairs, associated virtual volumes and pair status indicators.)

Components 802a-e operate in a similar manner as already discussed for the above examples. Broadly stated, array manager 802a utilizes original volume bitmap 822b, copied volume bitmap 823b and pair status 824 for managing original and copied volumes respectively. Array manager 802a further allocates portions of free storage 802d for storage of one or more virtual volumes that can be selectively created as corresponding to each copied volume, and that are managed in conjunction with virtual volume configuration information that can include time/date reference information 827a-d.

Original volume 822a, copied volume 823a and virtual volumes 824a-d further respectively store original, copied or resultant, and virtual or intermediate data portions sufficient to provide for rollback by copying ones of the data portions to a corresponding copied volume. Original volume bitmap 822b stores indicators indicating original volume portions, e.g., bits, blocks, groups, or other suitable segments, to which original data, if any, is written, while copied volume bitmap 823b stores indicators indicating copied volume portions to which (copied original or resultant) data, if any, is written. Sync/split status 824 stores an original-copied volume pair synchronization indicator indicating a Pair_Create or Split_Pair status of a corresponding such pair, e.g., 822a, 823a. Free storage pool 802d provides a (“free”) portion of disk array storage that is available for allocation to storage of at least virtual volumes corresponding to at least one copied volume, e.g., 823a. The free storage pool comprises a logical representation that can, for example, correspond to a volume portion (i.e., a volume in whole or part) a physical disk/drive portion, and so on.

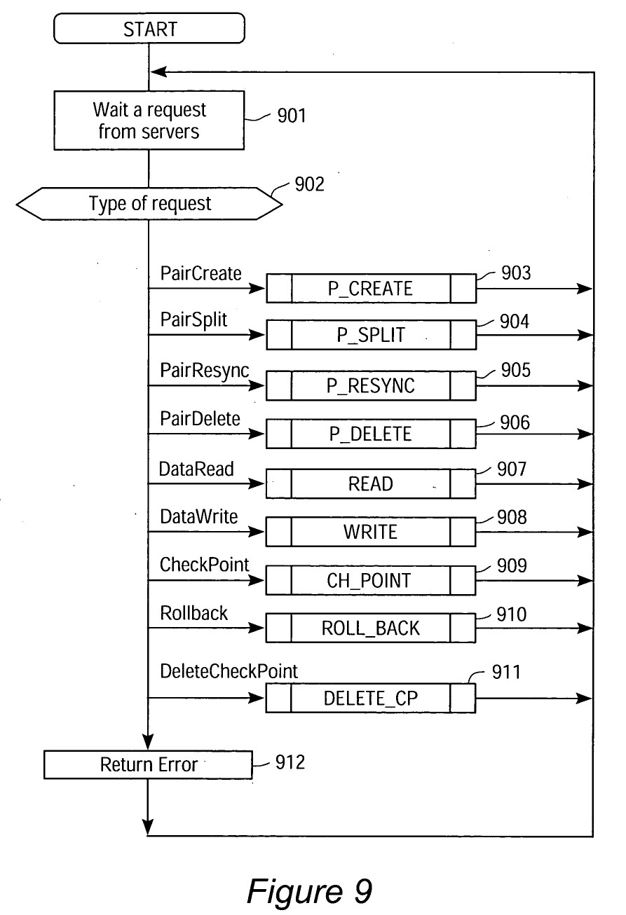

FIG. 9 illustrates an example of an array manager response to a received request (step 901) according to the request type, which request type array manager determines in step 902 (e.g., by polling a request or, for automatically initiated operation, using downloaded/stored information). In the following, however, it will be presumed that array manager operates only to requests received from a coupled server and that any automatic operation might be in a manner that is not inconsistent therewith.

Requests for the present example include volume I/O requests, pair operations, or virtual volume (or “snapshot”) operations. Volume I/O requests include Data_Read and Data_Write (steps 907-908). Pair operations include Pair_Create, Pair_Split, Pair (Re)Synchronize (“Resync”) and Pair_Delete (steps 903-906). Snapshot operations include Checkpoint, Rollback and Delete_Checkpoint (steps 909-911). Unsupported requests cause array manager 802a to return an error indicator (step 912).

(Such requests or error indicators can comprise the command configuration of FIG. 6 or another configuration in accordance with a particular implementation. It will also become apparent that such operations can be conducted with regard to one or more suitable volume portions, such as segments, that can be operated upon at once, successively or at convenient times/events, thereby enabling accommodation, for example, of limited system processing capabilities, varying application requirements, and so on.)

Broadly stated, Data_Read and Data_Write requests respectively provide for a server (e.g., 801a of FIG. 8) reading data from or writing to an original or secondary volume. Pair_Create, Pair_Split, Pair_Resync and Pair_Delete requests, respectively, provide for: initially inhibiting I/O requests to an original volume, creating a copied volume corresponding to an original volume and copying the original volume to the copied volume so that the two become identical; inhibiting primary to secondary volume synchronization; inhibiting read/write requests respecting and copying modified original volume portions to corresponding secondary volume portions; and “breaking up” an existing pair state of an Original volume and a Copied volume. (Note that a Pair_Delete request can also be used to break up or suppress synchronization of a Copied volume and Virtual volume pair. Alternatively, a user can opt to retain a paired state.)

CheckPoint, Rollback and Delete_Checkpoint requests further respectively provide for creating a virtual volume to which data written to a real data can be replicated; copying one or more data portions of one or more virtual volumes to a corresponding real volume, such that the virtual volume can provide a snapshot of a prior instance of the real volume; and deleting a virtual volume.

Comparison of Data Management Embodiments

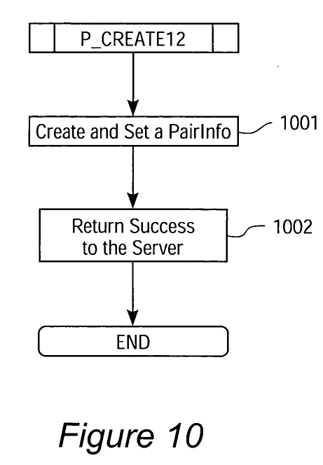

Continuing with FIG. 10 with reference to FIGS. 8 and 9, aspects of the invention enable a wide variety of replication system configurations. Three embodiments will now be considered in greater detail, each operating according to the receiving of the exemplary “instruction set” discussed with reference to FIG. 9. We will also presume that, in each of the three embodiments, the data replication system example of FIG. 8 is utilized and that array manager 792a responds to requests from server 811 by conducting all disk array 802 operations. Examples of alternative implementations will also be considered; while non-exclusive and combinable, these examples should also provide a better understanding of various aspects of the invention.

The three embodiments differ largely in the manner in which virtual volumes are stored or managed. However, it will become apparent that aspects are combinable and can further be tailored to the requirements of a particular implementation. The first or “same volume size” data replication embodiment (FIGS. 10 through 20b) utilizes virtual volumes having substantially the same size as corresponding copied volumes. The second or “extent-utilizing” data replication embodiment (FIGS. 10 and 21 through 25b) utilizes “extents” for storing overwritten data portions. The third or “log” data replication embodiment (FIGS. 10 and 26 through 32b) utilizes logs of replicated otherwise-overwritten or “resultant” data.

“Same Volume Size” Embodiment

The FIG. 10 flowchart illustrates an example of an array manager response to receipt of a Pair_Create request, which response is usable in conjunction with the above “same volume size” and “extent-utilizing” embodiments. (E.g., see steps 901-902 and 903 of FIG. 9.) The request includes indicators identifying an original volume and of a corresponding copied volume, which indicators can, for example, include SCSI logical unit numbers or other indicators according to a particular implementation. As shown, in step 1001, a volume management structure is created and populated with segment indicators and, assuming no substantial error occurs, a successful completion indicator is returned to the requester in step 1003.

(It will be appreciated that a successful completion indicator or other data can, in various embodiments, also be directed to another application, device and so on, for example, to provide for independent management, error recovery or backup, among other combinable alternatives. Other data, e.g., parameters, instructions, results, and so on, can also be redirected as desirable, for example, by providing a destination indicator or destination default.)

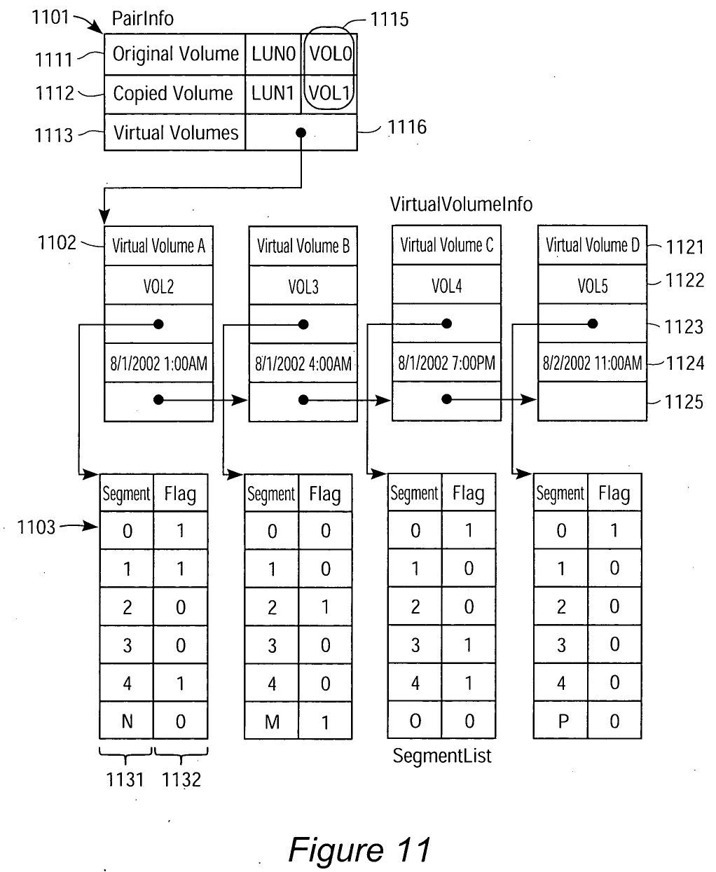

FIG. 11 illustrates an example of a volume management structure that can be used an array manager in conjunction with the “same volume size” data replication embodiment. In this embodiment, a virtual volume having a size that is substantially equivalent to that of a copied volume operates as a “shadow” volume storing shadow volume data that is substantially the same as the copied volume. Shadow volumes can also be allocated before a write request in received or “pre-allocated” where the size of a corresponding copied volume is already known. (Note, however, that different volumes can have different sizes with respect to different copied volume and corresponding virtual volume combinations and different segments can be differently sized in the same or different copied volume and corresponding virtual volume combinations.)

System 1100 includes pair information (“PairInfo”) 1101, virtual volume information (“VVol Info”) 1102 and segment information 1103 (here a virtual volume segment “list”). Note that additional such systems of data structures can be similarly configured for each original and copied volume pair, and any applicable virtual volumes.

PairInfo 1101 includes reference indicators or “identifiers” (here, a table having three rows) that respectively indicate an original volume 1111, a copied volume corresponding to the original volume 1112 and any applicable (0 to n) virtual volumes 113 corresponding to the copied volume. Original and copied volume identifiers include a requester volume ID 1114 used by a requester in accessing an original volume or a corresponding copied volume (e.g., “LUN0” and “LUN1”) of a real volume pair, and an internal ID 1115 that is used by the array manager for accessing the original or copied volume. PairInfo 1101 also includes a virtual volume identifier that, in this example, points to a first virtual volume management structure corresponding to a first virtual volume in a linked list of such structures, with each structure corresponding to a successive virtual volume.

(It will be appreciated in this and other examples herein that various other data structure configurations might also be used, which configurations might further be arranged, for example, using one or more of n-dimensional arrays, direct addressing, indirect addressing, linked lists, tables, and so on.)

Each VVolInfo (e.g., 1102) includes virtual volume identifiers and other data (here, a five entry table) that respectively indicate a virtual volume name 421, virtual volume (or “previous”) data 422, a segment table identifier 423, a timestamp 424 (here, including time and date information), and a next-volume link 425. In this example, requester virtual volume references enable a requester to specify a virtual volume by including, in the request, one or more of the virtual volume name 421 (e.g., Virtual Volumes A through N), a time or date of virtual volume creation, or a time or date that a closest (here, a next later time/date) or compared with the time/date requested can be determined. (An internal reference, for example, “Vol0 or Vol1, can be mapped to a requested Virtual Volume A”.)

(In the last, “desired date” example, a corresponding virtual volume can be selected, for example, by comparing the request time/date identifier with a timestamp 424 of created virtual volumes and selecting a later, earlier or closest virtual volume according to a selection indicator, default or other alternative selection mechanism. Other combinable references can also be used in accordance with a particular application.

Of the remaining VVolInfo information, virtual volume data 422 stores replicated or “previous” copied volume data (see above). Segment table identifier 423 provides a pointer to a segment table associated with the corresponding virtual volume. Next-volume link provides a pointer to a further (at least one of a next or immediately previously created) VVolInfo, if any.

A segment list (e.g., 1103) is provided for each created shadow volume and is identified by a VVol of Info of its corresponding shadow volume. Each segment list includes segment identifiers and replication (or replicated) indicators, here, as a two column table. As discussed above, volumes can be referenced as separated into one or more portions referred to herein as “segments”, one or more of which segments can be copied to a copied volume (pursuant to a Pair_Create) or replicated to a virtual volume pursuant to initiated modification of one or more copied volume segments.

The FIG. 11 example shows how each segment list can include a segment reference 1131 (here, a sequential segment number corresponding to the virtual volume), and a replicated or “written” status flag 1132. Each written status flag can indicate a reset (“0”) or set (“1”) state that respectively indicate, for each segment, that the segment has not been replicated from a corresponding copied volume segment to the shadow volume segment, or that the segment has been replicated from a corresponding copied volume segment to the shadow volume segment.

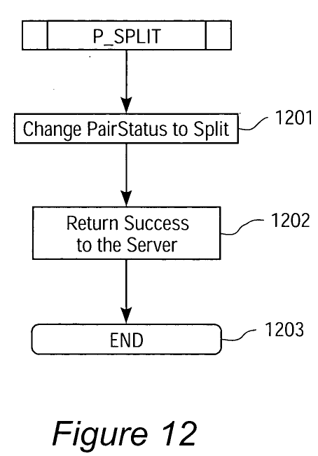

FIG. 12 illustrates an example of an array manager response to receipt of a Pair_Split request, which response is usable in conjunction with the above “same volume size”, “extent-utilizing” and “log” embodiments. (E.g., see steps 901-902 and 904 of FIG. 9.) The request includes indicators identifying an original volume and a corresponding copied volume, as with the above Pair_Create request. As shown, an array manager changes the PairStatus to split_pair in step 1201 and, assuming no substantial error occurs, a successful completion indicator is returned to the requester in step 1202.

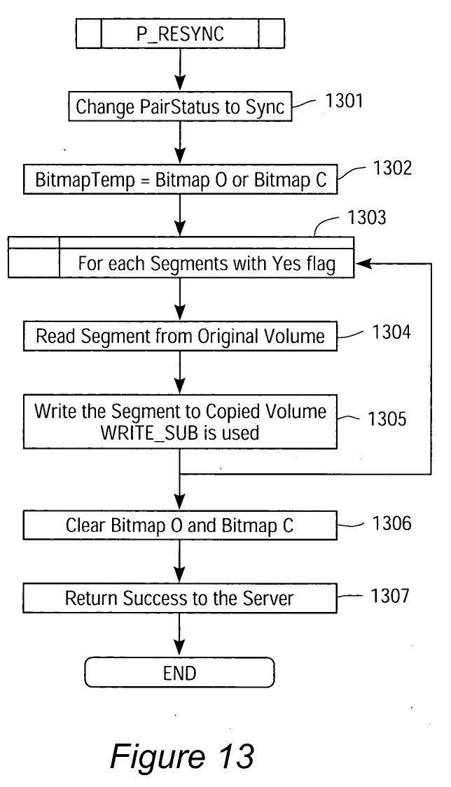

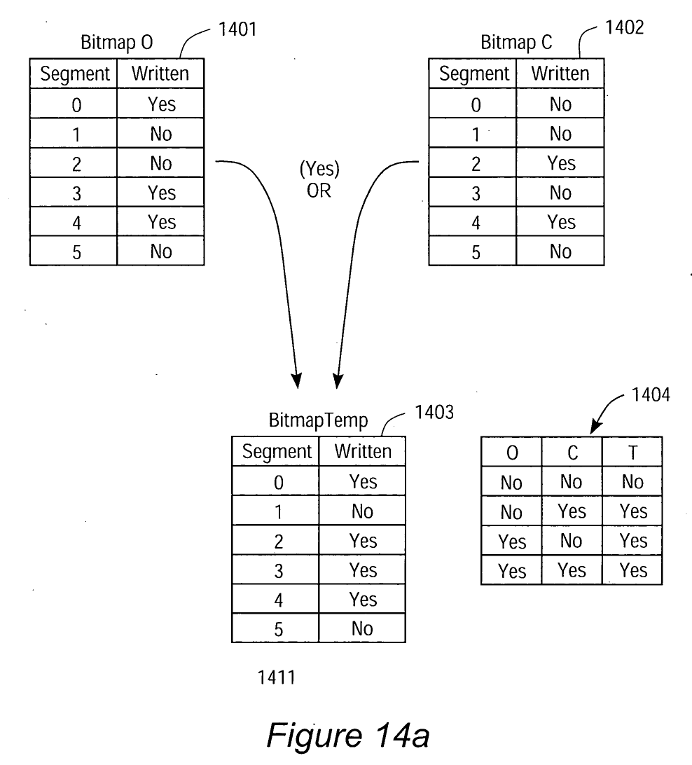

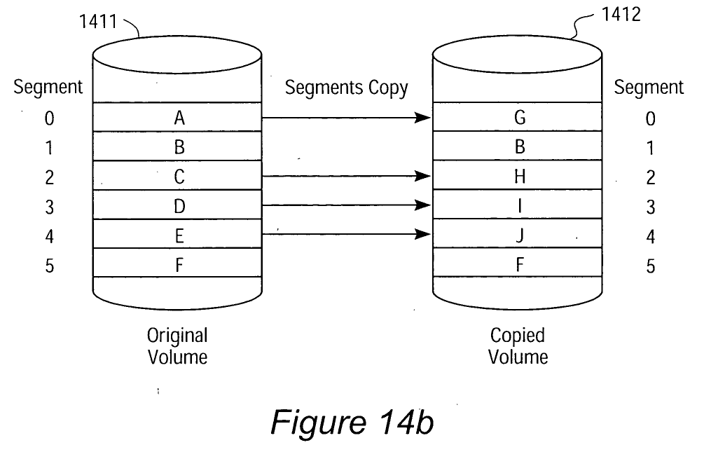

FIGS. 13, 14a and 14b illustrate an example of an array manager response to receipt of a Pair_Resync request, which response is usable in conjunction with the above “same volume size”, “extent-utilizing” and “log” embodiments. (E.g., see steps 901-902 and 905 of FIG. 9.) The request includes indicators identifying an original volume and of a corresponding copied volume, as with the above Pair_Create request.

Beginning with FIG. 13, an array manager (e.g., 802a) changes the PairStatus from pair_split to pair_sync in step 1301, and creates a temporary bitmap table in step 1302 (see FIG. 14a). The temporary bitmap table indicates modified segments (step 1303) that, for example, include copied volume segments modified during a pair_split state; such copied volume segments are overwritten from an original volume, thereby synchronizing the copied volume to the original volume, in steps 1304-1305. The bitmap table is then reset to indicate that modified original volumes have been copied to the copied volume in step 1306 and, assuming no substantial error occurs, a successful completion indicator is returned to the requester in step 1307.

FIG. 14a further illustrates an example of how a temporary bitmap table can be formed (step 1302 of FIG. 13) from an original volume bitmap table and a copied volume bitmap table (e.g., “Bitmap-O” 1401 and “Bitmap-C” 1402 respectively). As shown, each of tables 1401 through 1403 includes a segment indicator for each volume segment, and each segment indicator has a corresponding “written” indicator. A reset (“No”) written indicator indicates that a segment has not been written and thereby modified, while a set (“Yes”) indicator indicates that the segment has been written and thereby modified (e.g., after a prior copy or replication).

As shown in table 1404, temporary bitmap table 1403 is formed by OR'ing bitmap tables 1401 and 1402 such that a yes indicator for a segment in either of tables 1401 and 1402 produces a yes in table 1403. Once formed, the temporary bitmap table can be used to synchronize the copied volume with the original volume, after which tables 1401 and 1402 can be cleared by resetting the respective written indicators.

FIGS. 13 and 14b, with reference to FIG. 14a, further illustrate an example of the synchronizing of a copied volume. In this example, a segment copy operation (steps 1304-1305 of FIG. 13) copies from an original volume to a copied volume all segments that have been written since a last segment copy, e.g., as indicated by temporary bitmap 1403 of FIG. 14a. More specifically, if a written indicator for a segment of a corresponding temporary bitmap is set or “yes”, then the corresponding original volume segment is copied to the further corresponding copied volume segment, e.g., using one or more of a copy operation, the original volume segment Data_Read and segment copied volume Data_Write of FIG. 13 or a Data_Write from the original volume to the copied volume, such as that discussed below.

Temporary bitmap 1403, for example, provides for referencing six segments, and indicates a “yes” status for segments 0 and 2-4 and a “no” for segments 1 and 5. Thus, conducting copying from original volume 1411 (FIG. 14b) according to temporary bitmap 1403 (FIG. 14a), each of segments 0 and 2-4 of original volume 1411 is copied to segments 0 and 2-4 of copied volume 1412. More specifically, original volume has been modified as follows: segment 0 from data “A” to data “G”, segment 2 from data “C” to data “H”, segment 3 from data “D” to data “I”, and segment 4 from data “E” to data “J”. Following such copying, copied volume segments 0 and 2-4 will also respectively store data “G”, “H”, “I” and “J”, while copied volume segments 1 and 5, which previously included data “B” and “F” respectively, remain intact after copying. As a result, synchronization according to this first same volume size embodiment causes the original and copied volumes to become identical.

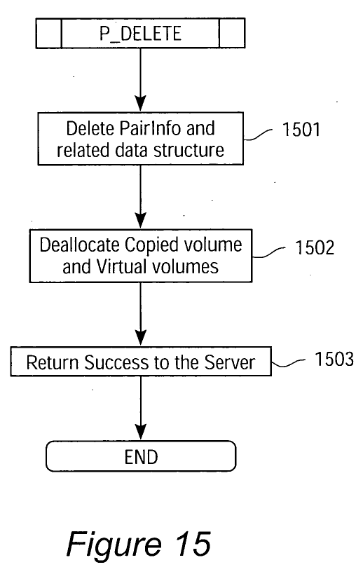

FIG. 15 illustrates an example of a response to receipt of a Pair_Delete request, which response is usable in conjunction with each of the above “same volume size”, “extent-utilizing” and “log” embodiments. (E.g., see steps 901-902 and 906 of FIG. 9.) The request includes indicators identifying a Copied volume.

As shown, in step 1501, an array manager deletes the data structures corresponding to the volume pair (and associated virtual volumes), such as a PairInfo, VVolInfo, Bitmap tables and so on. In step 1502, the array manager further de-allocates and returns allocated dataspaces to the free storage pool. Thus, in the “same volume size” embodiment, the indicated copied volume and dataspaces used for virtual volumes are returned. (Similarly, the extents of the below-discussed “extents” are returned, and associated log volumes of the below-discussed “log” embodiment are returned.) Finally, in step 1503, the array manager returns to the requester a successful completion indicator, if no substantial error occurs during the Pair_Delete.

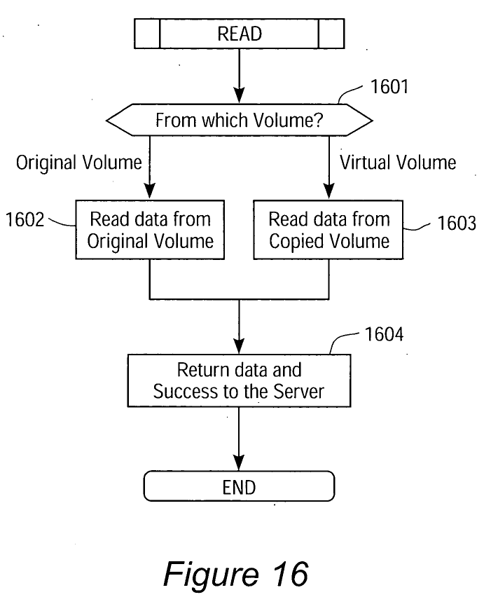

FIG. 16 illustrates an example of a response to receipt of a Data_Read request, which response is usable in conjunction with the above “same volume size”, “extent-utilizing” and “log” embodiments. (E.g., see steps 901-902 and 907 of FIG. 9.) The request includes indicators identifying a subject volume and a Data_Read as the command type. As shown, in step 1601, an array manager determines, by analyzing the request volume indicator, whether the subject volume is an original volume or a copied volume. If, in step 1601, the subject volume is determined to be an original volume, then, in step 1602, the array manager reads the indicated original volume; if instead the subject volume is determined to be a copied volume, then, in step 1603, the array manager reads the indicated copied volume. The array manager further, in step 1604 returns the read volume to the requester, and further returns to the requester a successful completion indicator, if no substantial error occurs during the Data_Read.

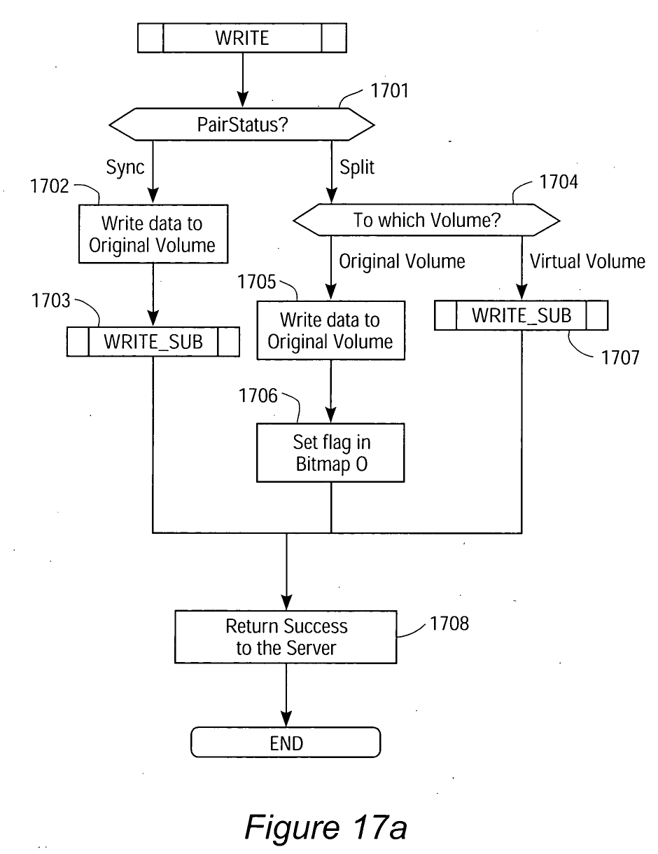

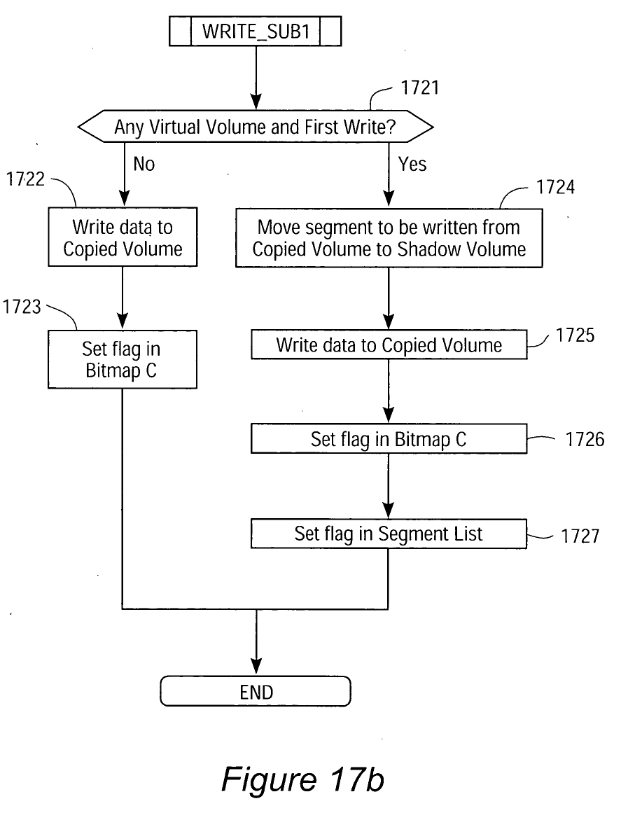

FIGS. 17a and 17b illustrate an example of a response to receipt of a Data_Write request, which response is generally usable in conjunction with each of the above “same volume size”, “extent-utilizing” and “log” embodiments. (E.g., see steps 901-902 and 908 of FIG. 9.) The request includes indicators identifying a subject volume and a Data_Write as the command type. As shown, in step 1701 (FIG. 17a), an array manager determines a current pair status for the current original-copied volume pair. If the pair status is “pair_sync”, then the array manager writes the request data to the indicated original volume (given by the request) in step 1702, initiates a write operation in step 1703 and, in step 1708, returns to the requester a successful completion indicator, if no substantial error occurs during the Data_Write.

If instead the current status is a pair_split, then the array manager determines the volume type to be written in step 1704. The array manager further, for a determined original volume, writes the request data to the indicated original volume in step 1705 and sets the original volume bitmap flag in step 1706, or for a copied volume, initiates a write operation in step 1708. In either case, the array manager returns to the requester a successful completion indicator, if no substantial error occurs during the Data_Write in step 1708.

FIG. 17b illustrates how, in an exemplary write procedure for the “same volume size” embodiment, an array manager first writes the included data to the corresponding copied volume in step 1721. The array manager further, in step 1722, determines if the current write is a first write to a segment of a last created virtual volume. The array manager more specifically parses the written indicators of the segment list associated with the last created virtual volume; the existence of a “yes” indicator indicates that the current write is not the first write to the last created virtual volume. If not, then the array controller writes the included data to the copied volume in step 1722, and sets the corresponding written segment indicator(s) of the associated copied volume bitmap in step 1723.

If instead, the current write is determined to be the first write to the last created virtual volume, then the array manager first preserves the existing copied volume data of the segment(s) to be written by replicating the copied volume to the last created virtual (“shadow”) volume in step 1724 before writing the data to the copied volume in step 1725 and setting the bitmap written indicator for the copied volume in step 1726. The array manager then further sets the corresponding written indicator(s) in the segment list corresponding to the last created shadow volume in step 1727.

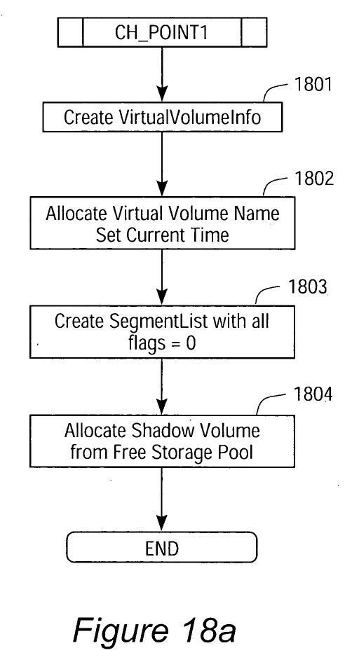

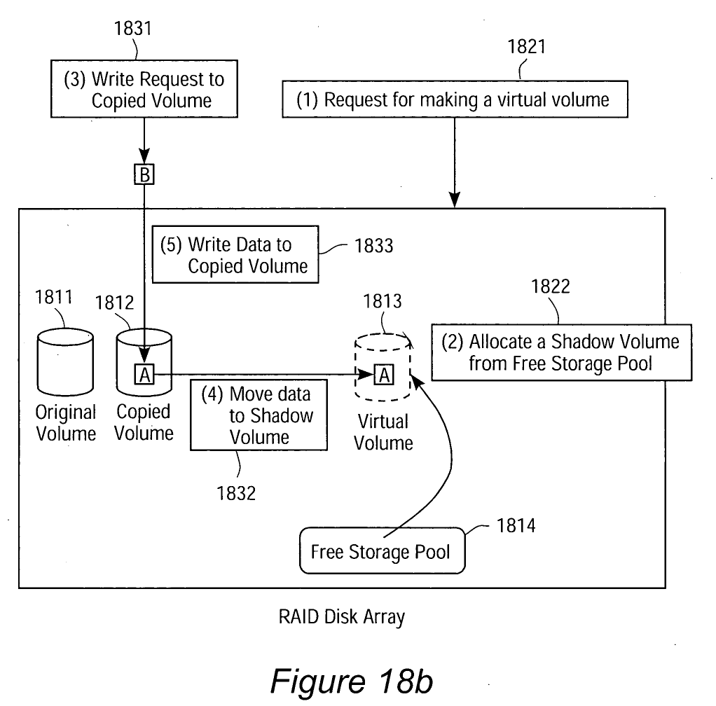

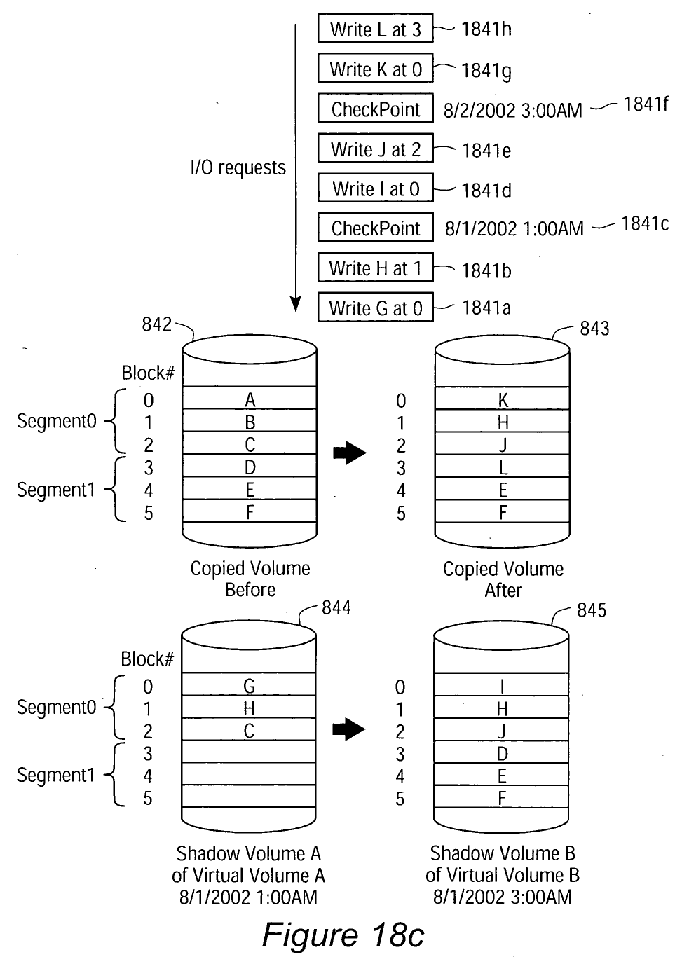

FIGS. 18a through 18c illustrate an example of a response to receipt of a Checkpoint request, which response is usable in conjunction with the above “same volume size” embodiment. (E.g., see steps 901-902 and 909 of FIG. 9.) The request includes indicators identifying a subject copied volume and a Checkpoint as the command type. The checkpoint request creates a virtual volume for the indicated copied volume.

Beginning with FIG. 18a, in step 1801, an array manager creates a virtual volume management structure or “VVolInfo”, which creating includes creating a new structure for the new virtual volume and linking the new structure to the existing structure (for other virtual volumes), if any. The array manager further allocates and stores a virtual volume name and timestamp for the new virtual volume in step 1802, creates and links a segment list having all written flags reset (“0”) in step 1803, and allocates a shadow volume (dataspace) from the free storage pool in step 1804. (As noted earlier, the shadow volume can be allocated at this point, in part, because the size of the shadow volume is known to be the same size as the corresponding copied volume.) A successful completion indicator might also optionally be returned to the requester if no substantial error occurs during the Checkpoint.

(A Checkpoint request in the present or other embodiments might further alternatively store, to the new virtual volume, included data included in the request, such that a single request creates a new virtual volume and also replicates a snapshot of the corresponding copied volume to the new virtual volume, e.g., as already discussed.)

FIGS. 18b and 18c further illustrate an example of an array controller operation that combines one or more Checkpoint and Data_Write requests. As in the FIG. 18a example, the Checkpoint request of the present example merely creates a new virtual volume without also storing virtual volume data. Additionally, for clarity sake, the present example is directed at virtual volume creation and virtual volume data storage only; creation and management of an associated management structure is presumed and can, for example, be conducted in accordance with the above examples.

In FIG. 18b, steps 1 and 2 illustrate a checkpoint request including (1) receiving and responding to a request for creating a virtual volume by (2) allocating a shadow volume from a free storage pool. Steps (3) through (5) further illustrate a Data_Write request to a corresponding copied volume including (3) receiving and responding to a request for writing data to the copied volume by: (4) moving the corresponding (existing) copied volume data to the created shadow volume; and (5) writing the requested data to the copied volume.

In FIG. 18c, we assume operation according to the FIG. 18b example and that requests 1841a-h are successively conducted by an array controller of a disk array having at least a copied volume 1842 to which the included Data_Write requests are addressed, and 0 virtual volumes. Segments 0-5 of copied volume 842, at time t=0, respectively include the following data: “A”, “B”, “C”, “D”, “E” and “F”. Copied volume 1843 is copied volume 842 after implementing requests 1841a-h.

First, Data_Write requests 1841a and 1841b respectively cause segments 0 and 1 (“A” and “B”) to be replaced with data “G” and “H”.

Checkpoint request 1841c then causes shadow volume 1844 to be created and subsequent Data_Write requests before a next Checkpoint request to be “shadowed” to shadow volume 1844. Next, Data_Write request 1841d (“I” at segment 0) causes segment 0 (now “G”) to be replicated to segment 0 of shadow volume 1844, and then copied volume segment 0 (“G”) to be replaced with “I”. Data_Write request 1841e to copied volume 842 segment 2 similarly causes the current data “C” to be stored to segment 2 of shadow volume 1844 and then copied volume 1842 segment 2 to be replaced by the included “J”.

Checkpoint request 1841f then causes shadow volume 845 to be created and subsequent Data_Write requests before a next Checkpoint request to be “shadowed” to shadow volume 1845. Next, Data_Write request 1841g (“K” at segment 0) causes segment 0 (now “I”) to be replicated to segment 0 of shadow volume 1844, and then copied volume segment 0 (“G”) to be replaced with “I”. Data_Write request 1841h to copied volume 1842 segment 3 similarly causes the current data “D” to be stored to segment 3 of shadow volume 1845 and then copied volume 1842 segment 3 to be replaced by the included data “L”.

As a result, segments 0-5 of copied volume 1845 (i.e., 1842 after requests 1841a-h) includes the following data: “K”, “H”, “J”, “L”, “E” and “F”. Shadow volume 1844, having a time stamp corresponding to the first Checkpoint request, includes, in segments 0 and 2 respectively, data “G” and “C”. Shadow volume 1845, having a time stamp corresponding to the second Checkpoint request, includes, in segments 0 and 3 respectively, data “I” and “D”.

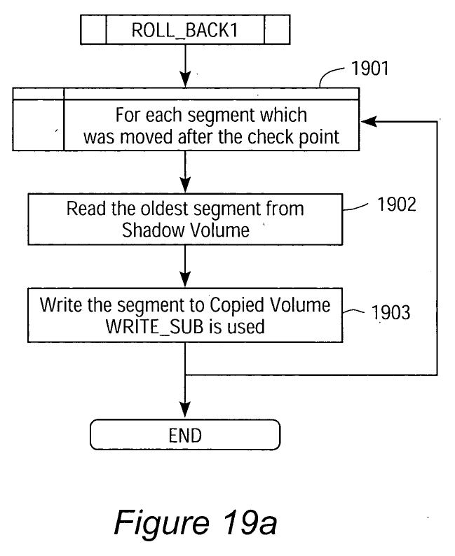

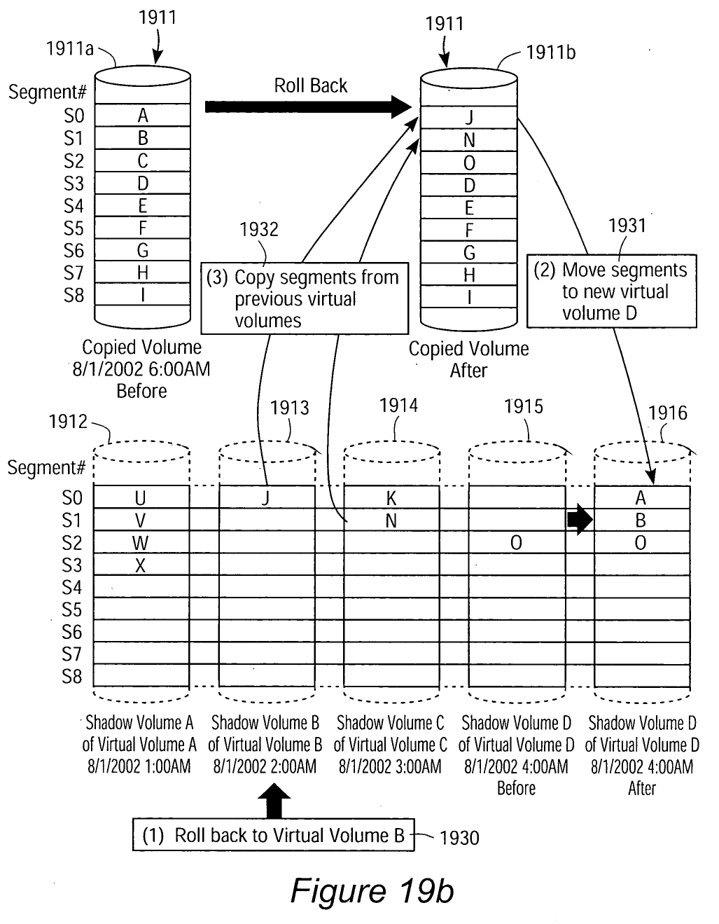

FIGS. 19a and 19b illustrate an example of a response to receipt of a Rollback request, which response is usable in conjunction with the above “same volume size” embodiment. (E.g., see steps 901-902 and 910 of FIG. 9.) The request includes indicators identifying a subject copied volume, a virtual or “shadow” volume identifier (e.g., name, time, and so on) and a Rollback as the command type. The Rollback request restores or “rolls back” the indicated secondary storage to a previously stored virtual volume. As noted, the restoring virtual volume(s) typically include data from the same copied volume. It will be appreciated, however, that alternatively or in conjunction therewith, virtual volumes can also store default data, data stored by another server/application control code, and so on, or a Rollback or other virtual volume affecting request might initiate other operations, e.g., such as already discussed.

Beginning with FIG. 19a, in step 1901, an array manager conducts steps 1902 through 1903 for each segment that was moved from the indicated secondary volume to a virtual or “shadow” volume, e.g., after an immediately prior Checkpoint request regarding the same copied volume. In step 1902, the array manager determines the corresponding shadow volume segment that is the “oldest” segment corresponding to the request, i.e., that was first stored to a shadow volume after the indicated time or corresponding virtual volume ID, and reads the oldest segment. Then, in step 1903, the array manager uses, e.g., the above-noted write operation to replace the corresponding copied volume segment with the oldest segment corresponding to the request. A successful completion indicator might also optionally be returned to the requester if no substantial error occurs during the Rollback (not shown).

FIG. 19b illustrates a further Rollback request example (steps 1930-1932) that is generally applicable to each of the aforementioned or other embodiments. In this example, before restoring a copied volume segment to data of an indicated virtual volume, the copied volume segment (or only data that will be overwritten, and so on) is preserved in a (here, further) virtual volume.

We assume for the present example that a Rollback request is successfully conducted by an array controller of a disk array having at least copied volume 1911 and shadow volumes 1912 through 1915 to which the Rollback request is addressed. Segments 0-8 of copied volume 1911, at time t=0, respectively include the following data: “A”, “1B”, “C”, “D”, “E”, “F”, “G”, “H” and “I”. Copied volume 1911b reflects copied volume 1911a after implementing the Rollback request.

Following receipt of the “Rollback to virtual (shadow) volume B” in step 1930, an array manager determines that the Rollback will replace segments 0 through 2 of copied volume 1911, and thus creates new virtual volume “D” 1916, e.g., as in the above examples, and stores such segments or “A”, “B” and “C” in new virtual volume segments 0 through 2 in step 1931. As with other examples herein, such determining can include one or more of utilizing segment identifying indicators in the Rollback request, or more typically, including null values within the indicated data (i.e., of the request) corresponding to unchanged data, or other suitable mechanisms can be used.

The array manager then replaces copied volume segments 0 through 2 with virtual volume segments in step 1932. More specifically, the array manager replaces copied volume segments 0 through 2 with the oldest shadow volume segments corresponding to the request (here, volume D), which include, in the present example: segment 0 or “J” of shadow volume B; segment 1 or “N” of shadow volume C (and not of SVol-C or “K”); and segment 2 or “Q” of shadow volume D.

The FIG. 19b example provides an additional advantage in that replaced real volume data can, in substantially all cases, be preserved and then utilized as desired by further restoring virtual volume data. Other data, i.e., including any control information, can also be restored or transferred among requesters or targets of requests, or additional instructions can be executed by array manager (e.g., see above). Thus, for example, virtual volumes can be used to conduct such transfer (e.g., by string requester, target or processing information) such that a source or destination that was known during a virtual volume affecting request need not be explicitly indicated or even currently known other than via virtual volume management information or other data. Further, while it may become apparent in view of the foregoing that, for example, storage device registers or other mechanisms might also be employed alternatively or in conjunction therewith for certain applications, virtual volume implementations can avoid a need to add at least some of such registers or other mechanisms, and can make more effective use of more intrinsic mechanisms having other uses as well.

Rollback also provides an example of a request instance that might also include, separately or in an integrated manner with other indicators, security, application, distribution destination(s) and so on. For example, security can be effectuated by limiting checkpoint, rollback, delete or replication operations to requests including predetermined security identifiers or additional communication with a requester might be employed (e.g., see FIGS. 7b-c). Responses can also differ depending on the particular requester, application or one or more included destinations (or application/destination indicators stored in a virtual volume, among other combinable alternatives. Rollback in particular is especially susceptible to such alternatives, since a virtual volume that might be restored to a real volume or further distributed to other volumes, servers or applications might contain sensitive data or control information.

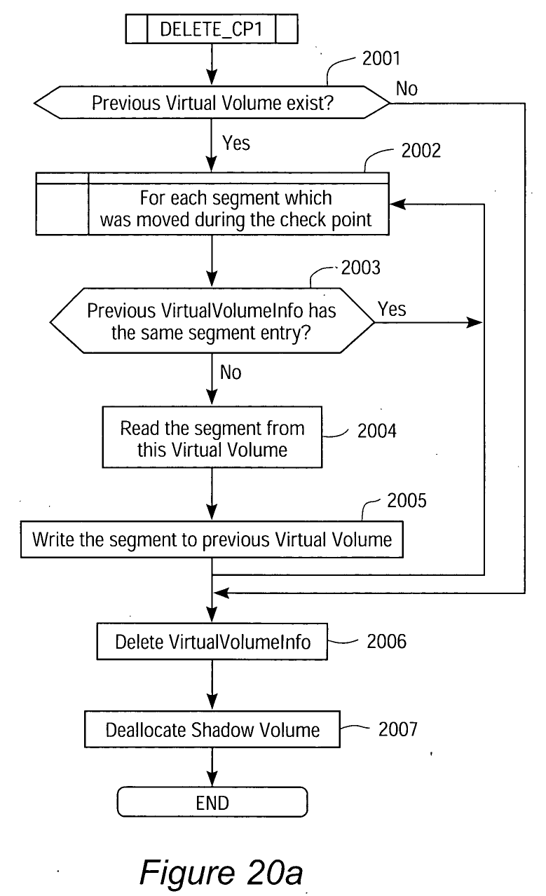

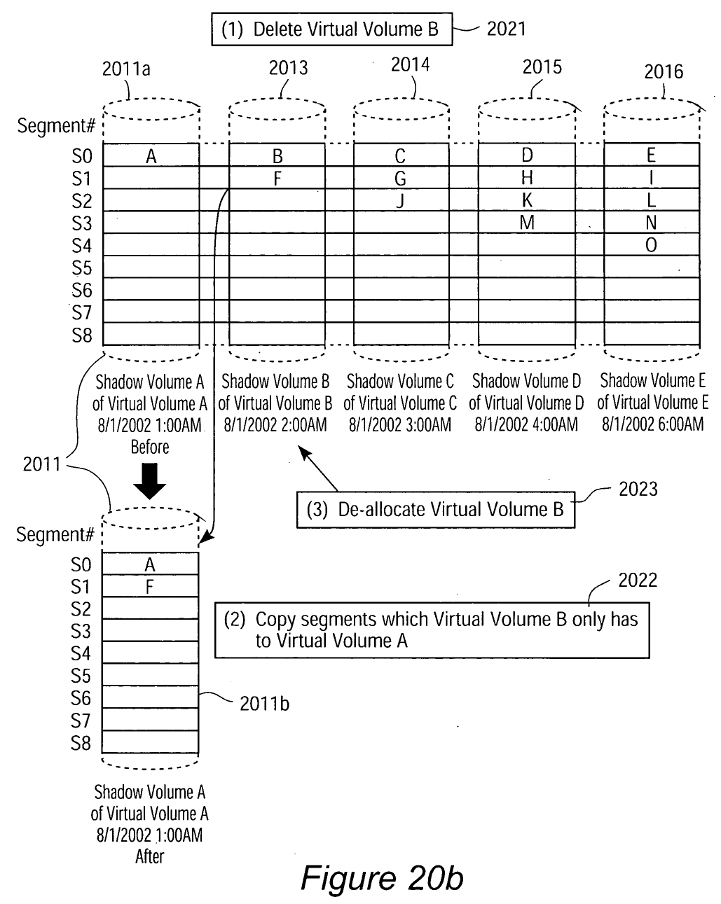

FIGS. 20a and 20b illustrate an example of a response to receipt of a Delete_Checkpoint request, which response is usable in conjunction with the above “same volume size” embodiment. (E.g., see steps 901-902 and 911 of FIG. 9.) The request includes indicators identifying a virtual or “shadow” volume identifier and a Delete_Checkpoint as the command type, and causes the indicated shadow volume to be removed from the virtual volume management structure. Delete_Checkpoint also provides, in a partial data storage implementation, for distributing deleted volume segments that are not otherwise available to at least one other “dependent” virtual volume, thereby preserving rollback utilizing such requests following the deletion. (In the present example, such segments are moved to the prior virtual volume before deleting the subject checkpoint.)

Beginning with FIG. 20a, in step 2001, an array manager determines if a previous or a prior virtual volume corresponding to the specified (indicated) virtual volume exists. If such a virtual volume does not exist, then the Delete_Checkpoint continues at step 2007; otherwise, the Delete_Checkpoint continues at step 2002, and steps 2003 through 2005 are repeated for each segment of the subject virtual volume that was moved during the subject virtual volume's Checkpoint (e.g., during subsequent Data_Write operations prior to a next Checkpoint).

In step 2003, the array manager determines if a previous virtual volume management structure has an entry for a current segment to be deleted. If so, then the current segment of the subject virtual volume is read in step 2003 and written to the same segment of the previous virtual volume in step 2005; otherwise, the Delete_Checkpoint continues with step 2003 for the next applicable segment.

In step 2007, the virtual volume management structure for the subject virtual volume is deleted, and in step 2008, the subject virtual volume is de-allocated. A successful completion indicator might also optionally be returned to the requester if no substantial error occurs during the Rollback (not shown).

A graphical example of a Delete_Checkpoint request is illustrated in FIG. 20b. In this example, which is applicable to the “same size volume” and other embodiments, a Delete_Checkpoint request indicating a subject virtual volume is received, wherein the subject virtual volume includes one or more “uniquely populated” segments that are not also populated in a prior virtual volume. The procedure therefore preserves the uniquely populated segment(s) by copying them to the prior virtual volume, and the procedure de-allocates the subject virtual volume and its associated management structures.

(Note that while the de-allocation might also delete the (here) de-allocated information, the present example avoids the additional step of deletion, and further enables additional use of the still-existing de-allocated information in accordance with the requirements of a particular application. It will also be appreciated that deletion merely provides for removing the subject volume from consideration of “still active” volumes or otherwise enabling unintended accessing of the deleted volume to be avoided using a suitable mechanism according to the requirements of the particular implementation.)

We assume for the present example that a Delete_Checkpoint request is successfully conducted by an array controller of a disk array having at least current and (immediately) prior virtual or “shadow” volumes, B and A 2012, 2011 respectively. Shadow volume 2011 is further represented twice including before the Delete_Checkpoint 2011a and after the Delete_Checkpoint 2011b respectively.

Following receipt of a “Delete Virtual Volume B” request in step 2220, an array controller determines that virtual volume B contains populated segments 0 and 1 (data “B” and “F”) and, by simple comparing, also determines that, of the corresponding segments of virtual volume A, segment 0 is populated (data “A”) while segment 1 is not. (Segment 1 of VVol. B is therefore uniquely populated with regard to the current Delete request as to segment 1.) Therefore, in step (2) of FIG. 20b, segment 1 of virtual volume B is copied to segment 1 of virtual volume A in step (2), such that segments 0 and 1 of virtual volume A include data “A” and “F”. Then, in step (3), virtual volume B is de-allocated.

“Extents” Embodiment

The second or “extents” embodiment also utilizes dataspaces allocated from a free storage pool for storing virtual volume information and other data. However, unlike the shadow volumes of the “same volume size” embodiment, allocated dataspace is not predetermined as the same size as a corresponding copied volume. Instead, extents can be allocated according to the respective sizes of corresponding copied volume segments. The present embodiment also provides an example (which can also be applicable to the other embodiments) in which dataspace is allocated in accordance with a current request for storing at least one virtual volume segment.

The following examples will again consider requests including pair operations (including Pair_Create, Pair_Split, Pair_Resync and Pair_Delete), volume I/O requests (including Data_Read and Data_Write), and snapshot operations (including CheckPoint, Rollback and Delete_Checkpoint); unsupported requests also again cause an array manager to return an error indicator, as discussed with reference to FIG. 9. The following requests can further be conducted for the extents embodiment in substantially the manner already discussed in conjunction with the same size embodiment and the following figures: Pair_Create in FIG. 10; Pair_Split in FIG. 12, Pair_Resync in FIG. 13; Pair_Delete in FIG. 15; Data_Read in FIG. 16; and Data_Write in FIG. 17a (e.g., see above).

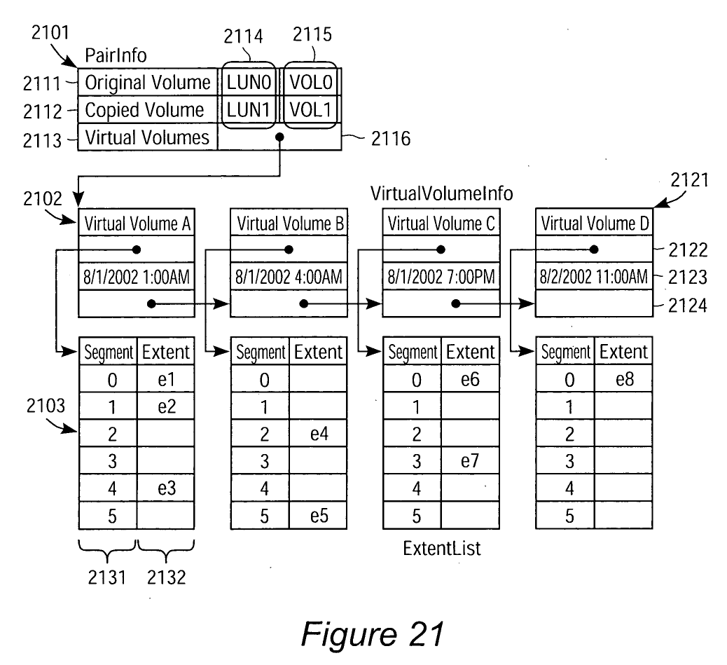

Turning now to FIG. 21, the exemplary volume management structure for the extents embodiment, as compared with the same volume size embodiment, similarly includes pair information (“PairInfo”) 2101, virtual volume information (“VVol Info”) 2102 and segment information 2103 in the form of a virtual volume segment “list”. Additional such systems of data structures can also be similarly configured for each original and copied volume pair, including any applicable virtual volumes, and PairInfo 2101 is also the same, in this example, as with the above-depicted same volume size embodiment.

In this example, however, each VVolInfo (e.g., 2102) includes virtual volume identifiers (here, a four entry table) that respectively indicate a virtual volume name 2121, a segment table identifier 2122, a timestamp 2124 and a next-volume link 2125. Requester virtual volume references enable a requester to specify a virtual volume by including, in the request, one or more of the unique virtual volume name 2121 (e.g., Virtual Volumes A through N), a time or date of virtual volume creation, or a time or date that a closest to the time/date requested can be determined as with the examples of the same volume size embodiment (e.g., see above). Finally, extent table identifier 2122 provides a pointer to a extent table associated with the corresponding virtual volume, and next-volume link provides a pointer to a further (at least one of a next or immediately previously created) VVolInfo, if any.

An extent segment or “extent” list (e.g., 2103) is provided for each created virtual volume of a copied volume and is identified by a VVol of info of its corresponding virtual volume. Each extent list includes segment identifiers (here, sequential numbers) and extent indicators or “identifiers” identifying, for each segment, an internal location of the extent segment. Extents are pooled in the free storage pool.

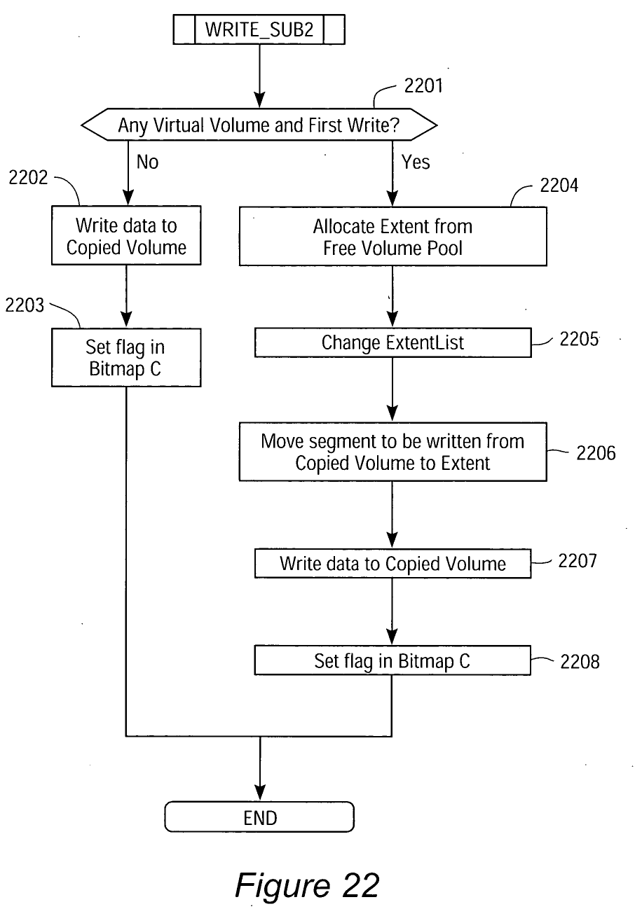

FIG. 22 illustrates an exemplary write procedure that can be used in conjunction with the “extents” embodiment. As shown, in step 2201, an array manager first determines if the current write is a first write to a segment of a last created virtual volume. The array manager more specifically parses the written indicators of the extent list associated with the last created virtual volume; the existence of a “yes” indicator indicates that the current write is not the first write to the last created virtual volume. If not, then the array controller writes the included data to the copied volume in step 2202, and sets the corresponding written segment indicator(s) of the associated copied volume bitmap in step 2203.

If instead, the current write is determined to be the first write to the last created virtual volume, then dataspace for extents can be allocated as the need to write to such dataspace arises and according to that specific need (e.g., size requirement), and pre-allocation can be avoided. Thus, in this example, the array controller first allocates an extent from the free volume pool in step 2204 and modifies the prior extent list (e.g., with an extent list pointer) to indicate that the extent has been allocated in step 2205. The procedure can then continue as with the same volume size embodiment. That is, the array controller preserves, by replicating, the corresponding segment of the copied volume to the to the current extent in step 2206, writes the indicated data to the copied volume in step 2207 and sets the corresponding bitmap written indicator for the copied volume in step 2208.

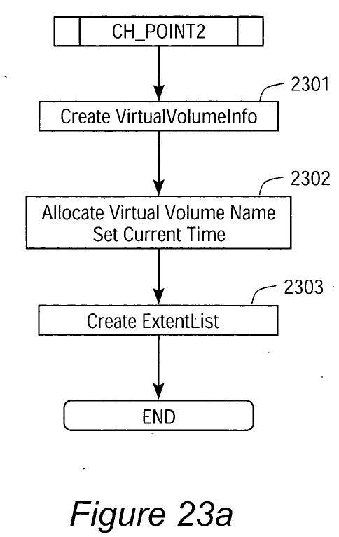

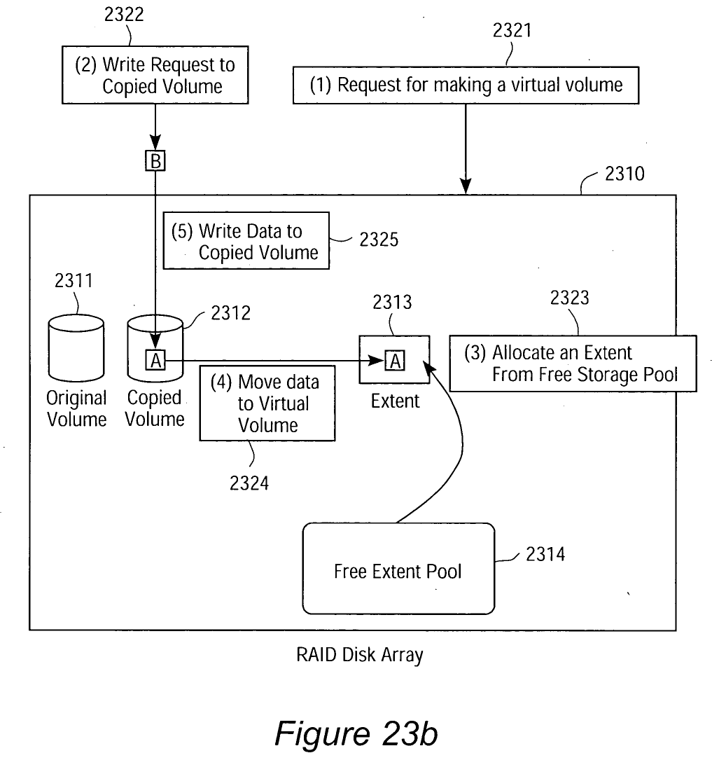

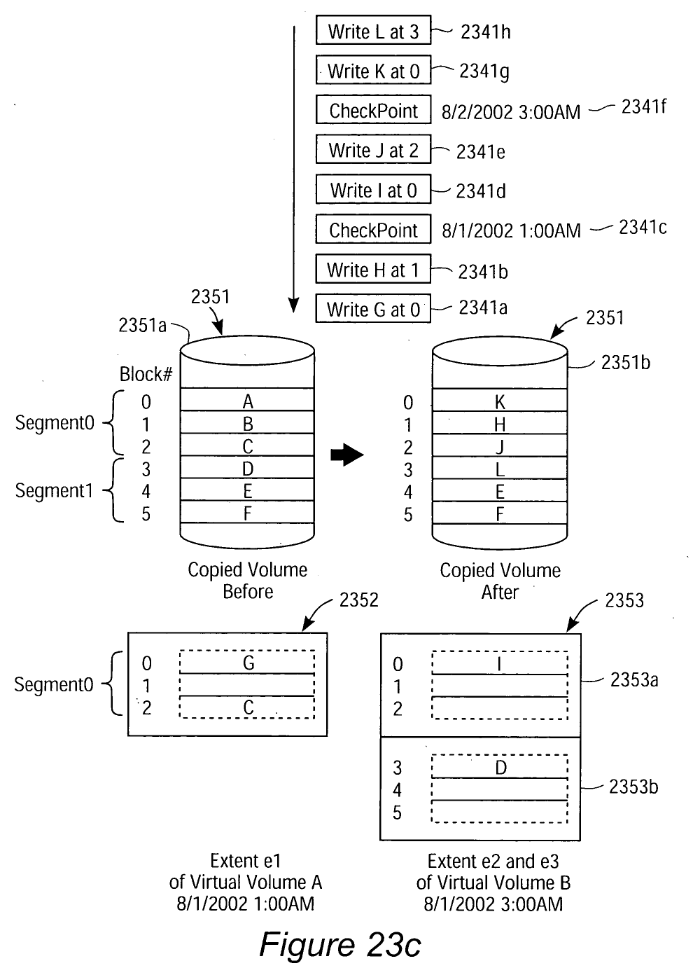

FIGS. 23a through 23c illustrate an example of a response to receipt of a Checkpoint request, which response is usable in conjunction with the above “extents” embodiment. (E.g., see steps 901-902 and 909 of FIG. 9.) The request includes indicators identifying a subject copied volume and a Checkpoint as the command type. The checkpoint request creates an extent-type virtual volume for the indicated copied volume.

Beginning with FIG. 23a, in step 2301, an array manager creates a “VVolInfo”, including creating a new virtual volume structure and linking the new structure to an existing structure, if any. The array manager further allocates and stores a virtual volume name and timestamp in step 1802, and creates an extent list in step 2303. A successful completion indicator might also optionally be returned to the requester if no substantial error occurs during the Checkpoint.

FIGS. 23b and 23c further illustrate an example of an array controller operation that combines one or more Checkpoint and Data_Write requests. As in the FIG. 23a example, the Checkpoint request merely creates a new virtual volume without also storing data. Additionally, for clarity sake, the present example is directed at virtual volume creation and data storage; therefore only exemplary management of an associated management structure that will further aid in a better understanding of the invention will be considered.

As shown in FIG. 23b a virtual volume creation request e.g., Checkpoint request is received and responded to in step (1). A Data_Write is then received indicating corresponding copied volume 2312 (2), in response to which a new extent-type virtual volume is allocated (3), a copied volume segment to be written is moved to the new extent (4) and the included data included in the response is written to the copied volume (5).

In FIG. 23c, we assume operation according to the FIG. 23b example, and further, that requests 2341a-h are successively conducted by an array controller of a disk array having at least a copied volume 1842 to which the included Data_Write requests are addressed, and 0 virtual volumes. Segments 0-5 of copied volume 2351, at time t=0, respectively include the following data: “A”, “B”, “C”, “D”, “E” and “F”. Copied volumes 2351a and 2351b are copied volume 2351 before and after implementing requests 2341a-h.

First, since no virtual volume yet exists, Data_Write requests 2341a-b merely replace segments 0 and 1 (data “A” and “B”) with data “G” and “H”.

Checkpoint request 2351c then causes management structures to be initialized corresponding to extent-type virtual volume 2352. Data_Write request 2341d (data “I” to segment 0), being the first post Checkpoint write request to copied volume 2351 segment 0, causes allocation of extent-e1 2352 and moving of copied volume 2351 segment 0 (now data “G”) to the latest extent (e1) segment 0. The included data (“I”) is then written to copied volume 2351 segment 0. Data_Write 2341e (data “J” to segment 2), being the second and not the first write request to copied volume 2351, is merely written to copied volume 2351 segment 2.

Checkpoint request 2341f then causes data management structures for extent 2353a to be created. Next, Data_Write request 2341g (“K” at segment 0), being the first post-Checkpoint write request to copied volume 2351 segment 0, causes allocation of extent-e2 2353a and moving of copied volume 2351 segment 0 (now data “I”) to the latest extent (e2) segment 0. The included data (“I”) is then written to extent 2353a segment 0. Data_Write 2341h (data “L” to segment 3), being the first post-Checkpoint write request to copied volume 2351 segment 3, causes allocation of extent 3 and writing of copied volume 2351 segment 3 to extent e3. Then the included data “J” is written to extent 2353b segment 3.

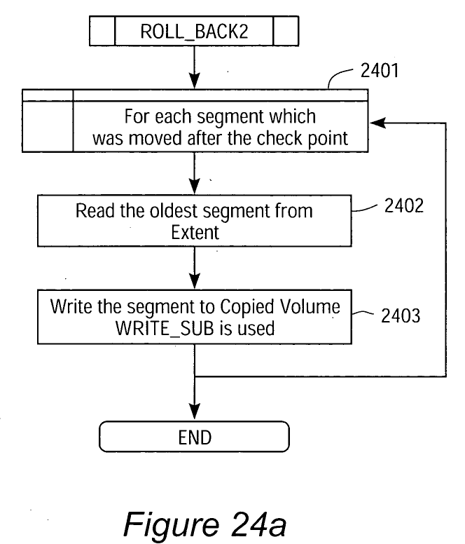

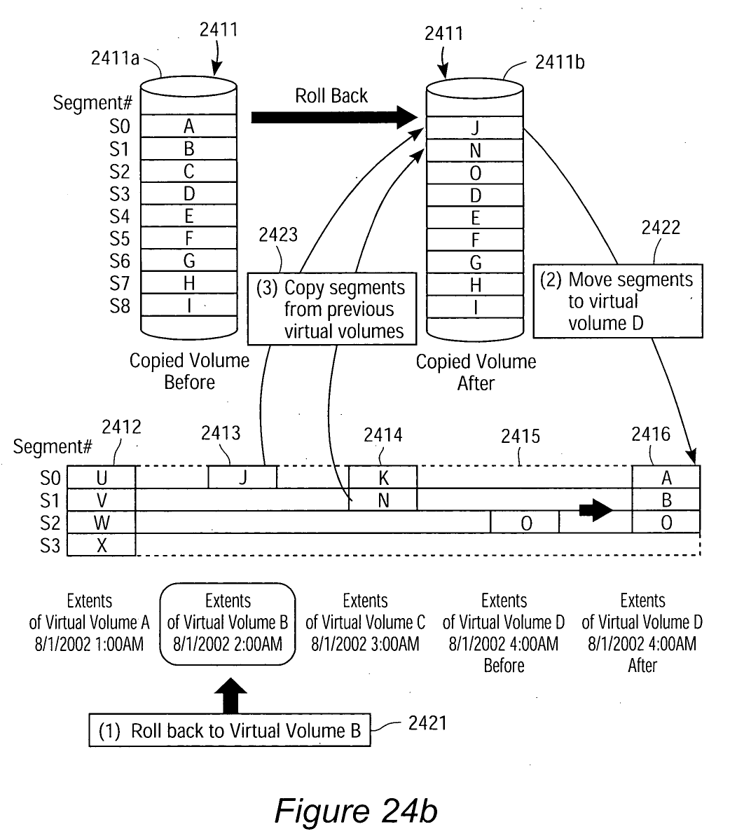

FIGS. 24a and 24b illustrate an example of a response to receipt of a Rollback request, which response is usable in conjunction with the above “extents” embodiment. (E.g., see steps 901-902 and 910 of FIG. 9.) The request includes indicators identifying a subject copied volume, an extent-type virtual volume identifier (e.g., name, time, and so on) and a Rollback as the command type. The Rollback request restores or “rolls back” the indicated copied volume data to a previously stored virtual volume. As noted, the restoring virtual volume(s) typically include data from the same copied volume.

Beginning with FIG. 24a, in step 1901, an array manager conducts steps 2402 through 2403 for each segment that was moved from the indicated copied volume to an extent-type virtual volume, e.g., after an immediately prior Checkpoint request regarding the same copied volume. In step 2402, the array manager determines the corresponding extent segment that is the “oldest” segment corresponding to the request, i.e., that was first stored to an extent after the indicated time or corresponding virtual volume ID, and reads the oldest segment. Then, in step 2403, the array manager uses, e.g., the above-noted extent-type write operation to replace the corresponding copied volume segment with the oldest segment corresponding to the request. A successful completion indicator might also optionally be returned to the requester if no substantial error occurs during the Rollback (not shown).

In the FIG. 24b example, we assume that a Rollback request is successfully conducted by an array controller of a disk array having at least copied volume 2411 and extents 2412 through 2416 to which the Rollback request is addressed. Segments 0-8 of copied volume 2411, at time t=0, respectively include the following data: “A”, “B”, “C”, “D”, “E”, “F”, “G”, “H” and “I”. Copied volumes 2411a-b reflect copied volume 1911 before and after implementing the Rollback request.

Prior to receipt of the “Rollback to virtual volume B” request in step 2421 and after the previous Checkpoint, the virtual volume B segments that were moved include S0 of virtual volume B, S0 of virtual volume C, S1 of virtual volume C and S2 of virtual volume D. Therefore, since the S0 of virtual volume B is older than S0 of virtual volume C, S0 of virtual volume B is selected. Then, since writes to S0 and S1 are first writes, the array manager allocates two extents for the latest virtual volume, and the copied volume segments S0 and S1, which are to be over-written, are moved to the allocated extents. (While the copied volume S2 will also be over-written, S2 is a second write after the latest virtual volume D has been created; therefore S2 is not also moved.) Next, the found virtual volume segments are written to the copied volume.

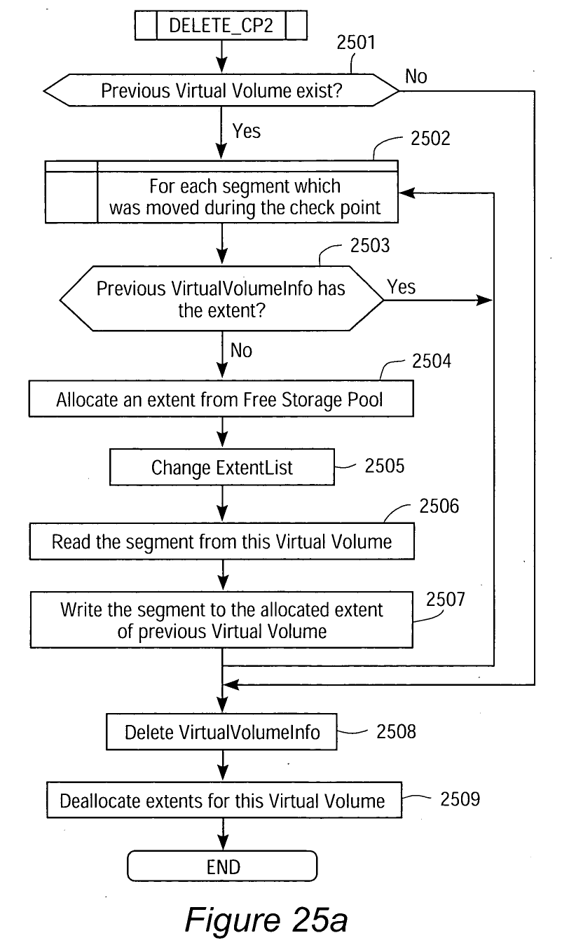

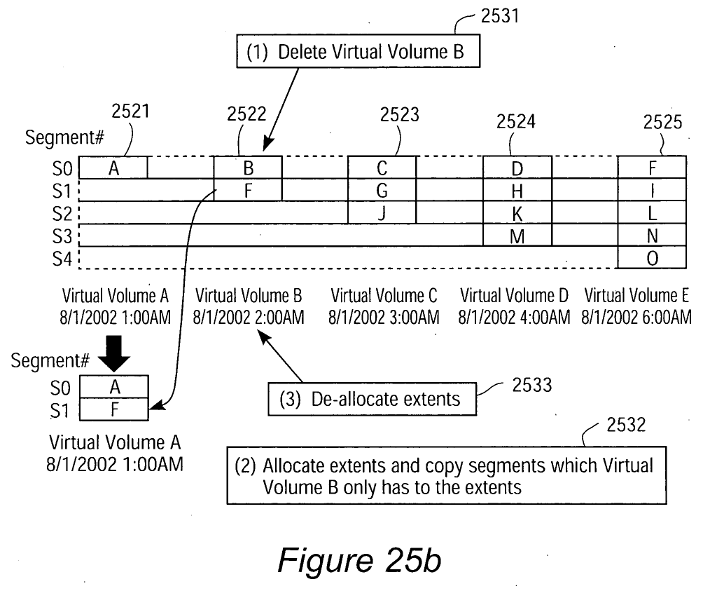

FIGS. 25a and 25b illustrate an example of a response to receipt of a Delete_Checkpoint request, which response is usable in conjunction with the above “extents” embodiment. (E.g., see steps 901-902 and 911 of FIG. 9.) The request includes indicators identifying a virtual volume identifier and a Delete_Checkpoint as the command type, and causes the indicated virtual volume to be removed from the virtual volume management structure. Delete_Checkpoint can also provide, in a partial data storage implementation, for distributing deleted volume segments that are not otherwise available to at least one other “dependent” virtual volume, thereby preserving remaining selectable rollback. (In the present example, such segments are moved to the prior virtual volume prior to deleting the subject Checkpoint.)

Beginning with FIG. 25a, in step 2501, an array manager determines if a previous virtual volume to that indicated exists. If such a virtual volume does not exist, then the Delete_Checkpoint continues at step 2508; otherwise, the Delete_Checkpoint continues at step 2502, and steps 2003 through 2005 are repeated for each segment of the subject virtual volume that was moved during the subject virtual volume's Checkpoint (e.g., during subsequent Data_Write operations prior to a next Checkpoint).

In step 2502, the array manager determines if a previous virtual volume includes a segment corresponding with the segment to be deleted in step 2504. If not, then the array manager allocates an extent from the free storage pool in step 2504 and modifies a corresponding extent list to include the allocated extent in step 2505. The array manager further moves the found segment to the extent of the previous virtual volume in steps 2506-2507, deletes the corresponding virtual volume information in step 2508 and de-allocates the subject extent in step 2509. If instead a previous virtual volume does include a corresponding segment, then the array manager deletes the corresponding virtual volume information in step 2508 and de-allocates the subject extent in step 2509. A successful completion indicator might also optionally be returned to the requester if no substantial error occurs during the Rollback (not shown).

A graphical example of a Delete_Checkpoint request is illustrated in FIG. 25b. In this example, a Delete_Checkpoint request indicating a subject virtual volume is received, wherein the subject virtual volume includes one or more “uniquely populated” segments that are not also populated in a prior virtual volume. The procedure therefore preserves at least a portion of the uniquely populated segment(s) by copying them to a new virtual volume, and the procedure de-allocates the subject virtual volume and its associated management structures.

In this example, virtual volume B 2522 will be deleted. An array manager searches extents allocated to virtual volume B and thereby finds segment S0 with data “B” and S1 with data “F”. Since virtual volume A 2021 has a segment S0 with data, the array manager allocates an extent for S1 of virtual volume A and moves the S1 with data “F” to the allocated extent. The array manager then de-allocates extents allocated to the virtual volume B and their associated data structures.

“Log” Embodiment

The third or “log” embodiment also utilizes dataspaces allocated from a free storage pool for storing virtual volume information and other data. However, unlike shadow volumes or extents, data storage and management is conducted via a log.

The following examples will again consider requests including pair operations (including Pair_Create, Pair_Split, Pair_Resync and Pair_Delete), volume I/O requests (including Data_Read and Data_Write) and snapshot operations (including CheckPoint, Rollback and Delete_Checkpoint); unsupported requests also again cause an array manager to return an error indicator, as discussed with reference to FIG. 9. The following requests can further be conducted for the log embodiment in substantially the manner already discussed in conjunction with the same size embodiment and the following figures: Pair_Split in FIG. 12, Pair_Resync in FIG. 13; Pair_Delete in FIG. 15; Data_Read in FIG. 16; and Data_Write in FIG. 17a (e.g., see above).

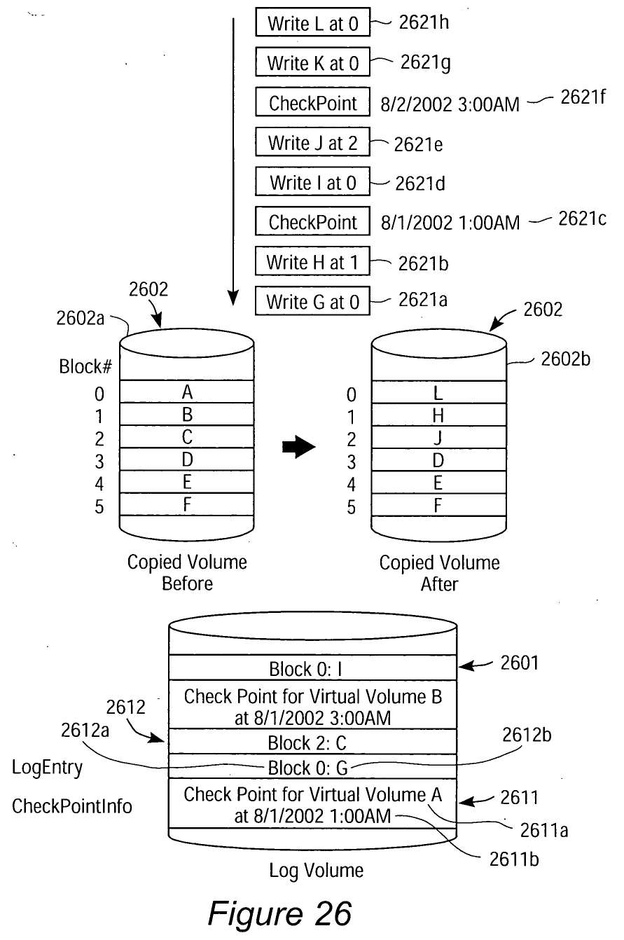

FIG. 26 illustrates an example of a log-type virtual volume 2601 comprising two types of entries, including at least one each of a checkpoint (start) indicator 2611 and a (write) log entry 2612. (More than one log can also be used, and each log can further include a name. For example, one or more such logs can be used to comprise each virtual volume or one or more virtual volumes might share a log, according to the requirements of a particular embodiment.)

Checkpoint entry 2611 stores information about a log entry that can include the depicted virtual volume identifier or “name” 2611a and a timestamp 2611b. Each log entry, e.g., 2612, includes a segment indicator 2612a identifying a copied volume segment of a corresponding real volume from which data was replicated (and then over-written), and the replicated data 2612b. For example, log entry 2612 entry “Block 2: C” was copied from segment “2”, here a block, of the corresponding copied volume, e.g., 2602, and data “C”.

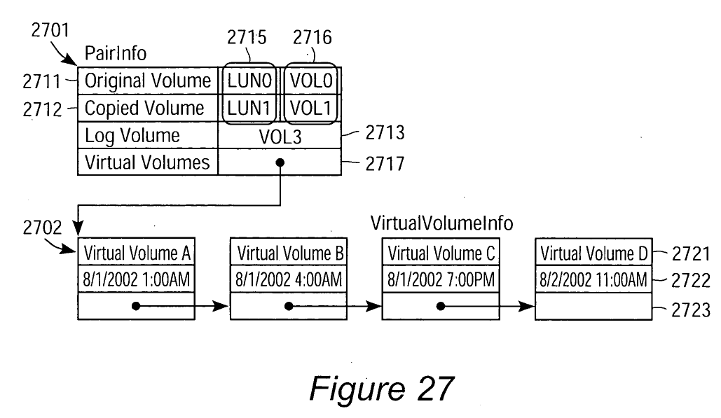

Turning now to FIG. 27, the exemplary volume management structure for the log embodiment includes pair information (“PairInfo”) 2701 and virtual volume information (“VVol Info”) 2702. The volume management structure also includes checkpoint and segment information within the log (as discussed with reference to FIG. 26. Additional such systems of data structures can also be similarly configured for each original and copied volume pair, including any applicable virtual volumes.

More specifically, the present PairInfo 2701 includes, for each of original and corresponding copied volume 2711, 2712, an external reference 2715 and internal reference, as already discussed for the same volume size embodiment. PairInfo 2701 also includes a log volume, e.g., as discussed with reference to FIG. 26, and a virtual volume indicator or “link” that points to a first V.Vol_Info. (As in other examples, a V.Vol_Info structure can be formed as a linked list of tables or other suitable structure. (Note that, here again, the size of a log volume can be predetermined and allocated according to known data storage requirements or allocated as needed for storage, e.g., upon a Checkpoint or Data_Store, in accordance with the requirements of a particular implementation.)

Each VVolInfo (e.g., 2702) includes virtual volume identifiers (here, a three entry table) that respectively indicate a virtual volume name 2721, a timestamp 2722 and a next-volume indicator or “link” 2723.

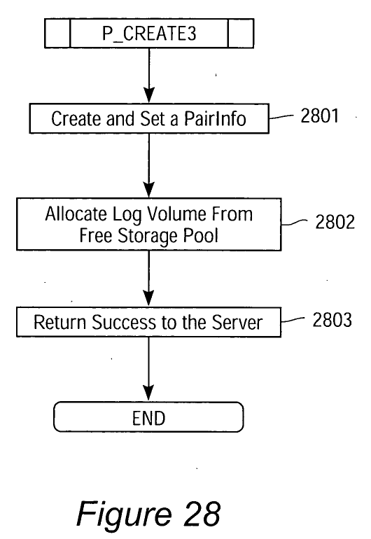

The FIG. 28 flowchart illustrates an example of an array manager response to receipt of a Pair_Create request, which response is usable in conjunction with the log embodiment and creates a pair. (E.g., see steps 901-902 and 903 of FIG. 9.) The request includes indicators identifying an original volume and of a corresponding copied volume, which indicators can, for example, include SCSI logical unit numbers or other indicators according to a particular implementation. As shown, in step 2801, a PairInfo is created and populated with original and copied volume information, and, in step 2802, allocates a log from a free storage pool, further setting a log volume identifier in the PairInfo. Finally, assuming no substantial error occurs, a successful completion indicator is returned to the requester in step 2803.

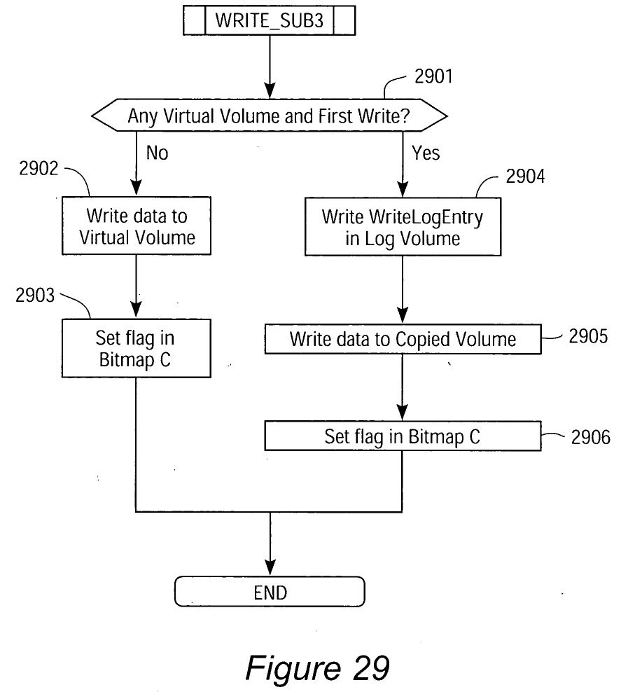

FIG. 29 illustrates an exemplary write procedure that can be used in conjunction with the “logs” embodiment. As shown, in step 2901, an array manager first determines if one or more virtual volumes exist for the indicated copied volume, and further, if the current write is a first write to a segment of a last created virtual volume.

The array manager more specifically parses the log entries in a corresponding log volume. If the determination in step 2901 is “no”, then the array manager writes the included data to the virtual volume in step 2902 and sets a written flag of a corresponding segment in a Bitmap-C table for the copied volume in step 2903. If instead the determination in step 2901 is “yes”, then the array manager writes a write log entry for the indicated segment (i.e., to be written within the copied volume) in step 2904, writes the included data to the copied volume in step 2905, and sets a written flag of the corresponding segment in the Bitmap-C table in step 2906.

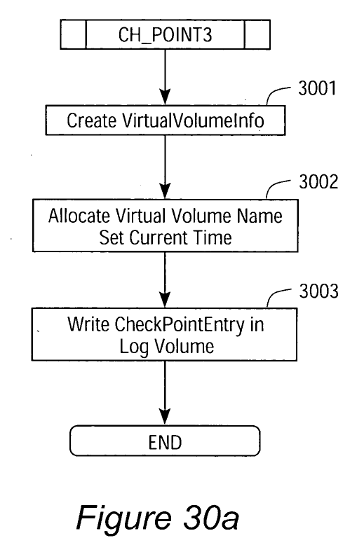

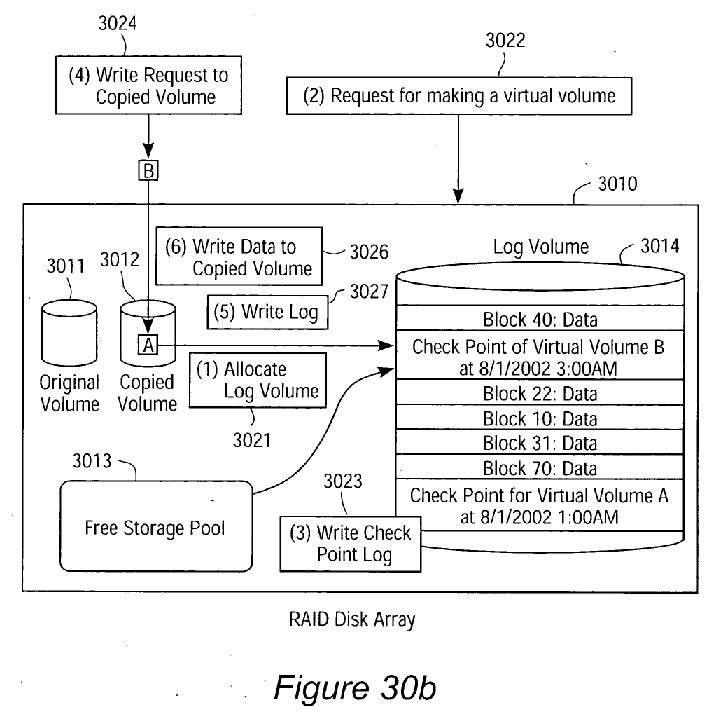

FIGS. 30a-b and 26 illustrate an example of a response to receipt of a Checkpoint request, which response is usable in conjunction with the above “log” embodiment. (E.g., see steps 901-902 and 909 of FIG. 9.) The request includes indicators identifying a subject copied volume and a Checkpoint as the command type. The checkpoint request creates a log-type virtual volume for the indicated copied volume.

Beginning with FIG. 30a, in step 3001, an array manager creates a “VVollnfo”, including creating a new virtual volume structure and linking the new structure to (a tail of) an existing structure, if any. The array manager further, in step 3002, allocates and stores a virtual volume name, sets a current time as a timestamp, and in step 3003, writes a corresponding checkpoint entry into the log volume. A successful completion indicator might also optionally be returned to the requester if no substantial error occurs during the Checkpoint.

FIGS. 30b and 26 further illustrate an example of an array controller operation that combines one or more Checkpoint and Data_Write requests. For clarity sake, the present example is directed at virtual volume creation and data storage; therefore only exemplary management of an associated management structure that will aid in a better understanding of the invention will be considered.

In FIG. 30b example, when a pair is created, a log volume is allocated from free storage pool 3013 in step 3021. Then, when a request for creating a virtual volume, e.g., Checkpoint request, is received in step 3022, the array manager writes a checkpoint entry in the log volume in step 3023. Then, when a Data_Write request is received in step 3024, the array manager writes a write log entry into the log volume if needed, e.g., of a copied volume segment to preserve the segment when it is overwritten, in step 3025. Finally, the array manager (over)writes the copied volume segment in step 3026.

Returning to FIG. 26, we assume operation according to the FIG. 30a example, and further, that requests 2621a-h are successively conducted by an array controller of a disk array having at least a copied volume 1842 to which the included Data_Write requests are addressed, and 0 virtual volumes. Segments 0-5 of copied volume 2602, at time t=0, respectively includes the following data: “A”, “B”, “C”, “D”, “E” and “F”. Copied volumes 2602a depicts copied volume 2602 before implementing requests 2621a-h, while and copied volume 2602b and log 2610 depict results after implementing requests 2611a-h.

When the Data Writes 2621a-b (“Write G at 0” and “Write H at I”) are processed, no virtual volume yet exists, such that data “G” and “H” are merely written at segments (here, blocks) 0 and 1 respectively of copied volume 2602.

When Checkpoint request 2621c is received and processed at “Aug. 1, 2002 1:00 AM”, the array manager creates log 2601 and writes to log 2601a corresponding checkpoint entry. Next, when Data_Write 2621d (“Write I at 0”) is processed, the array manager determines that this is the first write to copied volume 2602 segment 0, and therefore, writes a write log entry for preserving copied volume segment 0 (data “G”), and then writes the indicated data (“I”) to copied volume 2602 segment 0. The array manager similarly responds to Data_Write request 2621e (“Write J at 2”) by replicating copied volume 2602 segment 2 (data “G”) to log 2601 and then writing the indicated data “J” to copied volume 2602 segment 2.

When Checkpoint request 2621f is received and processed at “Aug. 1, 2002 3:00 AM”, the array manager creates log 2601 and writes to log 2601a corresponding checkpoint entry. Next, when Data_Write 2621g (“Write K at 0”) is processed, the array manager determines that this is the first write to copied volume 2602 segment 0 (again, after a latest checkpoint), and therefore, writes a write log entry for preserving copied volume segment 0 (data “I”), and then writes the indicated data (“K”) to copied volume 2602 segment 0. The array manager similarly responds to Data_Write request 2621e (“Write L at 0”), this is the second and not the first write to that segment; therefore, the array manager merely writes the indicated data (“L”) to copied volume 22602 segment 0.

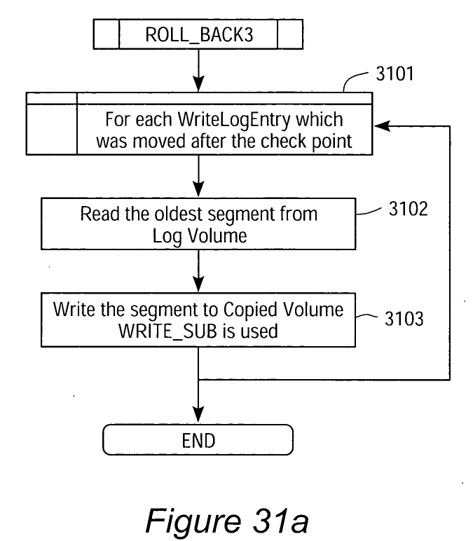

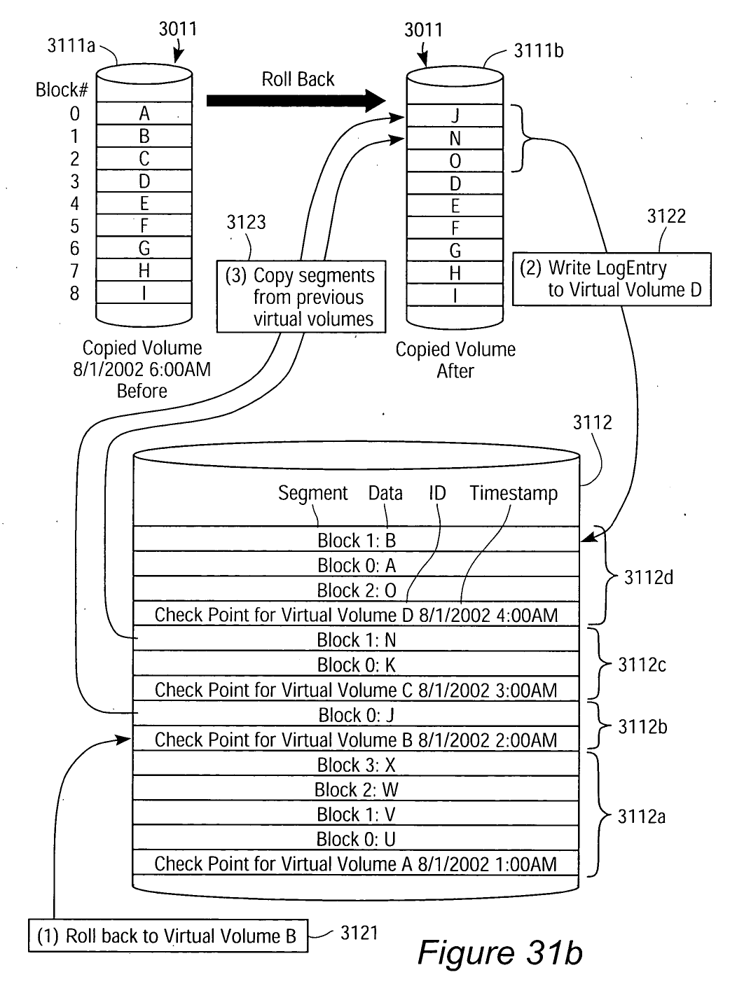

FIGS. 31a and 31b illustrate an example of a response to receipt of a Rollback request, which response is usable in conjunction with the above “log” embodiment. (E.g., see steps 901-902 and 910 of FIG. 9.) The request includes indicators identifying a subject copied volume, a log-type virtual volume identifier (e.g., name, time, and so on) and a Rollback as the command type. The Rollback request restores or “rolls back” the indicated copied volume data to a previously stored virtual volume. As noted, the restoring virtual volume(s) typically include data from the same copied volume.

Beginning with FIG. 31a, in step 3101, an array manager conducts steps 2402 through 2403 for each segment that was moved from the indicated copied volume to the indicated log-type virtual volume, e.g., after an immediately prior Checkpoint request regarding the same copied volume. In step 3102, the array manager determines the corresponding log segment that is the “oldest” segment corresponding to the request, i.e., that was first stored to the log after the indicated time or corresponding virtual volume ID, and reads the oldest segment. Then, in step 3103, the array manager uses, e.g., the above-noted log-type write operation, to replace the corresponding copied volume segment with the oldest segment corresponding to the request. A successful completion indicator might also optionally be returned to the requester if no substantial error occurs during the Rollback (not shown).

In the FIG. 31b example, we assume that a Rollback request is successfully conducted by an array controller of a disk array having at least copied volume 3111 and log 3112 to which the Rollback request is addressed. Segments 0-8 of copied volume 3111, at time t=0, respectively include the following data: “A”, “B”, “C”, “D”, “E”, “F”, “G”, “H” and “I”. Copied volumes 2411a-b reflect copied volume 1911 before and after implementing the Rollback request.

Prior to receipt of the “Rollback to virtual volume B” request in step 3121, virtual volume or “checkpoint” B has been created and includes block-based segment 0 (storing data “J”), already created checkpoint C includes blocks 0-1 (storing “K” and “N”), and already created checkpoint D includes blocks 0-2 (storing “A”, “B” and “Q”). The array manager determines, e.g., by comparing structure position or date, that virtual volumes B-D will apply and thus populated virtual volume segments 0-2 will replace those of copied volume 3111. The array manager further determines that, of checkpoint blocks beginning with the indicated checkpoint B, blocks CP-B:0, CP-C:1 and CP-D:2 are the oldest or “rollback” segments, and should be used to rollback copied volume 3111. Therefore, the array controller creates a new CP, replicates copied volume segments 0-2 to the new CP and then copies the rollback segments to corresponding segments of copied volume 3111.

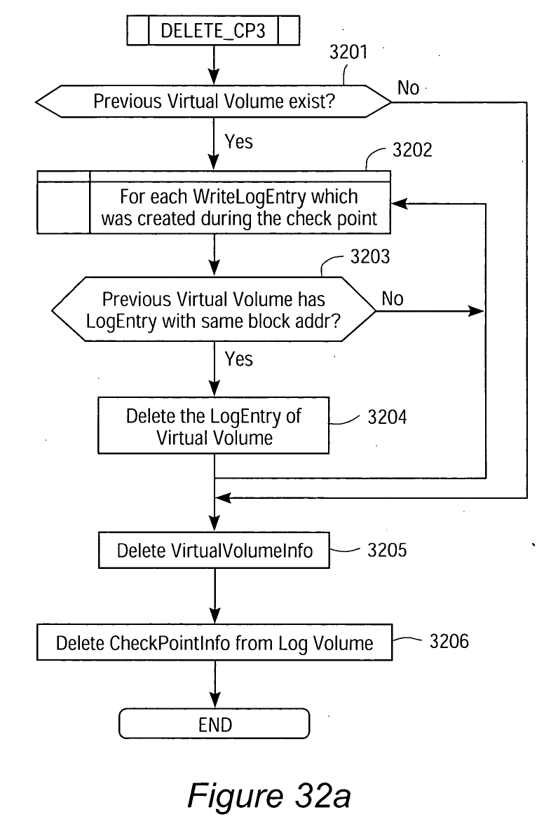

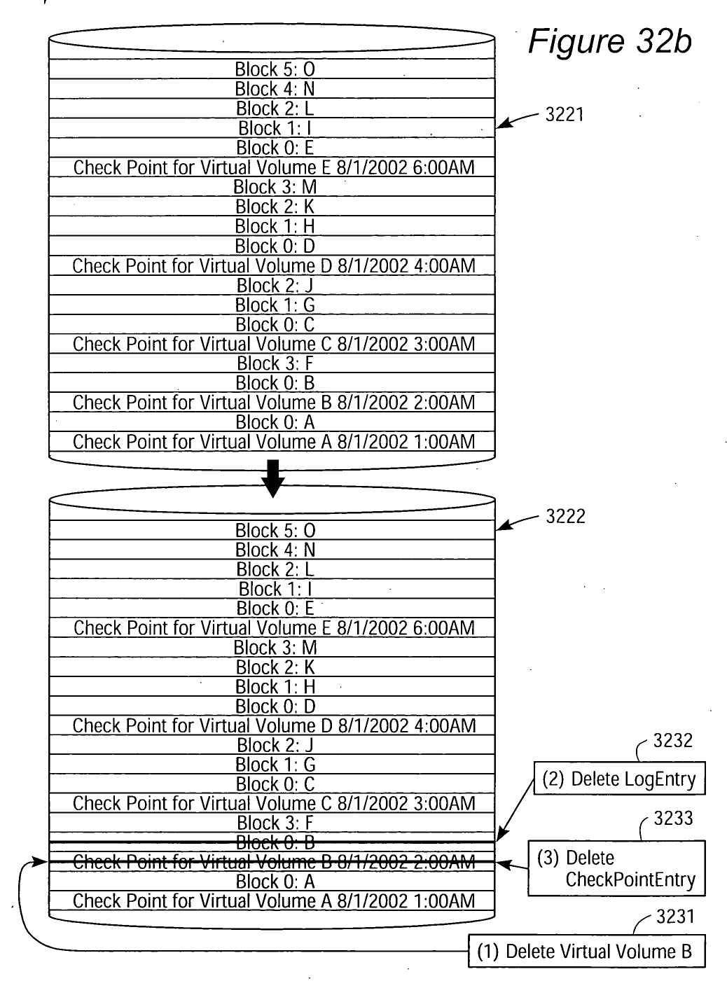

FIGS. 32a and 32b illustrate an example of a response to receipt of a Delete_Checkpoint request, which response is usable in conjunction with the above “log” embodiment. (E.g., see steps 901-902 and 911 of FIG. 9.) The request includes indicators identifying a virtual volume identifier and a Delete_Checkpoint as the command type, and causes the indicated virtual volume to be removed from the virtual volume management structure. Delete_Checkpoint also provides, in a partial data storage implementation, for distributing deleted volume segments that are not otherwise available to at least one other “dependent” virtual volume, thereby preserving remaining selectable rollback.

Beginning with FIG. 32a, in step 3201, an array manager determines if there is any virtual volume that was created before the indicated virtual volume. If so, then the array manager searches write log entries of the indicated virtual volume (step 3202) and, for each “found” write log entry, the array manager determines if a previous virtual volume has a write log entry with the same segment (here, using “blocks”) as a current write log entry in step 3203. If so, then the array manager deletes the current write log entry in step 3204; otherwise, the array manager keeps the log entry in step 3205. Following step 3205 or if no previous virtual volume was so created in step 3201, then, in step 3206, the array manager deletes the checkpoint entry for the indicated virtual volume from the log.

A graphical example of a Delete_Checkpoint request is illustrated in FIG. 32b. In this example, virtual volume-B 3112b is indicated for deletion. The array manager thus searches write log entries of virtual volume-B 3112b and at least one prior virtual volume (here, A) to determine whether the populated segments in virtual volume-B are also populated in the prior virtual volume. The search, in this example, indicates the following “found” segments: V.Vol-B includes block 0 (storing data “B”) and V.Vol-A also includes block 0. Since V.Vol-A also includes block 0, the array manager deletes the write entry for V.Vol-B block 0 from the log. (If V.Vol-B included other segments, the searching and applicable deleting of write entries corresponding to such a prior also-populated segment would be repeated for each such indicated volume segment.) The array manager then deletes the indicated checkpoint entry (here, for V.Vol-B) and de-allocates the data management structure(s) corresponding to V.Vol-B.

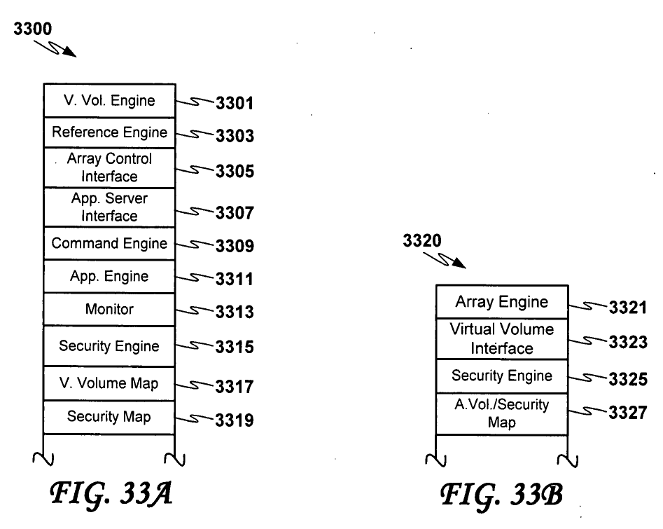

FIGS. 33a and 33b illustrate further examples of a virtual volume manager 3300 and an array controller 3320 respectively of a lesser integrated implementation.

Beginning with FIG. 33a, virtual volume manager 3300 includes virtual volume engine 3301, reference engine 3303, array control interface 3305, application interface 3307, command engine 3319, application engine 3311, monitor 3313, security engine 3315, virtual volume map 3317 and security map 3319. Virtual volume engine 3301 provides for receiving virtual volume triggers and initiating other virtual volume components. Reference engine 3303 provides for managing virtual volume IDs and other references, e.g., secondary volumes, application servers, applications, users, and so on, as might be utilized in a particular implementation. As discussed, such references might be downloadable, assigned by the reference engine or provided as part of a virtual volume trigger or as stored by an array controller, and might be stored in whole or part in virtual volume map 3319.

Reference engine 3303 also provides for retrieving and determining references, for example, as already discussed. Array control interface 3305 provides for virtual volume manager 3300 interacting with an array controller, for example, in receiving virtual volume commands via or issuing commands to an array controller for conducting data access or support functions (e.g., caching, error correction, and so on). Command engine 3307 provides for interpreting and conducting virtual volume commands (e.g., by initiating reference engine 3303, array control interface 3305, application engine 3311 or security engine 3315.

Application engine 3309 provides for facilitating specific applications in response to external control or as implemented by virtual volume manager 3300. Application engine 3309 might thus also include or interface with a java virtual machine, active-X or other control capability in accordance with a particular implementation (e.g., see above). Such applications might include but are not limited to one or more of data backup, software development or batch processing.

Of the remaining virtual volume components, monitor engine 3313 provides for monitoring storage operations, including one or more of a host device, other application server or array controller. Security engine 3315 provides for conducting security operations, such as permissions or authentication, e.g., see above, in conjunction with security map 3319. Virtual volume map 3317 and security map 3319 provide for storing virtual volume reference and security information respectively, e.g., such as that discussed, in accordance with a particular implementation.

Array controller 3320 (FIG. 33b) includes an array engine 3321 that provides for conducting array control operations, for example, in the manner already discussed. Array controller 3320 also includes virtual volume interface 3323 and security engine 3323. Virtual volume interface 3323 provides for inter-operation with a virtual volume manager, for example, one or more of directing commands to a virtual volume manager, conducting dataspace sharing, interpreting commands or conducting virtual volume caching, error correction or other support functions, and so on. Finally, security engine 3305 operates in conjunction with security map 3307 in a similar manner as with corresponding elements of the virtual volume manager 3300 of FIG. 33a, but with respect to array dataspaces, such as primary and secondary volumes.

While the present invention has been described herein with reference to particular embodiments thereof, a degree of latitude of modification, various changes and substitutions are intended in the foregoing disclosure, and it will be appreciated that in some instances some features of the invention will be employed without corresponding use of other features without departing from the spirit and scope of the invention as set forth.

What is claimed is:

1. A method performed by a storage device, comprising:
(a) initializing a data management system storing indicators for managing accessing of one or more virtual storage dataspaces corresponding to a first real data storage dataspace of at least the storage device;
(b) responding to one or more first triggers by replicating one or more data portions from the first real storage dataspace to a corresponding one of the virtual storage dataspaces;
(c) responding to one or more second triggers by moving at least one of the replicated data portions from the one or more virtual storage dataspaces to a second real storage dataspace; and
(d) modifying the data management system to indicate at least one of the replicating and moving.

2. A method according to claim 1, wherein the storage device comprises a multiple access storage device including a primary real volume (“primary volume”), a secondary real volume (“secondary volume”) and means for copying a primary volume portion of the primary volume to the secondary volume.

3. A method acccording to claim 2, wherein the first and second real volumes are a same secondary volume of the multiple access storage device.

4. A method according to claim 1, wherein the data management system comprises a virtual volume manager and a volume data management structure.

5. A method according to claim 1, wherein at least one of the initializing and the responding to the one or more first triggers further comprises allocating a virtual storage dataspace and storing a timestamp corresponding to at least one of the allocating and the replicating.

6. A method according to claim 1, wherein the responding to the one or more second triggers further comprises, prior to the moving at least one of the replicated data portions, moving one or more second data portions from the first real storage dataspace to one or more of the virtual storage dataspaces.

7. A method according to claim 1, wherein the responding to one or more first triggers comprises responding to a virtual storage dataspace creation request by creating a corresponding virtual storage dataspace, and responding to one or more subsequent copied storage dataspace data write requests including data by replicating the data to the virtual storage dataspace.

8. A method according to claim 1, wherein the managing accessing includes allocating at least one of: a virtual storage dataspace having a same size as the first real storage dataspace; a virtual storage dataspace storing a replicated data portion as one or more extents; and a virtual volume storing replicated data portion within one or more logs.

9. A method according to claim 8, wherein the one or more first triggers includes a request to write data to a real storage dataspace, and the allocating is conducted prior to the request to write data.

10. A method according to claim 8, wherein the managing accessing comprises storing, within a log, a virtual storage dataspace creation indicator including a timestamp corresponding to a time of virtual storage dataspace creation, and a write entry including a segment identifier and a replicated data segment.

11. A storage device comprising:
a virtual volume engine for responding to one or more first triggers by replicating one or more data portions from a first real storage dataspace to a corresponding one more virtual storage dataspaces, and for responding to one or more second triggers by moving at least one of the replicated data portions from the one or more virtual storage dataspaces to a second real storage dataspace; and
a data management system for initializing storage indicators indicating accessing of the one or more virtual storage dataspaces, and for modifying the indicators to indicate at least one of the replicating and moving.

12. A storage device according to claim 11, wherein the storage device comprises a multiple access storage device including a primary volume, a secondary secondary volume and means for copying a primary volume portion of the primary volume to the secondary volume.

13. A storage device acccording to claim 12, wherein the first and second real volumes are a same secondary volume of the multiple access storage device.

14. A storage device according to claim 11, wherein at least one of the initializing and the responding to the one or more first triggers further comprises allocating a virtual storage dataspace and storing a timestamp corresponding to at least one of the allocating and the replicating.

15. A storage device according to claim 11, wherein the responding to the one or more second triggers further comprises, prior to the moving at least one of the replicated data portions, moving one or more second data portions from the first real storage dataspace to one or more of the virtual storage dataspaces.

16. A storage device according to claim 11, wherein the responding to one or more first triggers comprises responding to a virtual storage dataspace creation request by creating a corresponding virtual storage dataspace, and responding to one or more subsequent copied storage dataspace data write requests including data by replicating the data to the virtual storage dataspace.

17. A storage device according to claim 11, wherein the virtual volume engine allocates virtual storage dataspaces as at least one of: a virtual storage dataspace having a same size as the first real storage dataspace; a virtual storage dataspace storing a replicated data portion as one or more extents; and a virtual volume storing replicated data portion within one or more logs.

18. A storage device according to claim 17, wherein the one or more first triggers includes a request to write data to a real storage dataspace, and the virtual volume engine allocates virtual storage dataspaces prior to the request to write data.

19. A storage device according to claim 17, wherein the data management system stores, within a log, a virtual storage dataspace creation indicator including a timestamp corresponding to a time of virtual storage dataspace creation, and a write entry including a segment identifier and a replicated data segment.

20. A computer storing program for causing the computer to perform the steps of:
(a) initializing a data management system storing indicators for managing accessing of one or more virtual storage dataspaces corresponding to a first real data storage dataspace of at least the storage device;
(b) responding to one or more first triggers by replicating one or more data portions from the first real storage dataspace to a corresponding one of the virtual storage dataspaces;
(c) responding to one or more second triggers by moving at least one of the replicated data portions from the one or more virtual storage dataspaces to a second real storage dataspace; and
(d) modifying the data management system to indicate at least one of the replicating and moving.

21. A method performed by a storage system, the method comprising the steps of:
providing a first volume and a second volume, the second volume being a replicated volume of the first volume;
creating a copy of the second volume at a first point in time;
updating the second volume in response to at least a write request; and
restoring the second volume at the first point in time using the copy.

22. A method performed by a storage system having a first volume and a second volume, the second volume being a replicated volume of the first volume, the method comprising the steps of:
providing a third volume;
if a first data change request is made to a first location in the second volume where no data change has been made since a first point in time, storing to the third volume the same data that is written at the first location;
making data change to the first location in response to the first data change request; and
restoring the second volume at the first point in time using data stored in the third volume.

23. A method according to claim 22, further comprising the steps of:
providing a fourth volume;
if a data change request is made to a second location in the second volume where no data change has been made since a second point in time, the second point in time being after,
storing to the forth volume the same data that is written at the second location;
making a data change to the second location in response to the second data change request; and
restoring the second volume at the second point in time using data stored in the fourth volume.

24. A method according to claim 23, wherein the first location is the same as the second location.
